(19) United States
(12) Patent Application Publication
(10) Pub. No.: US 2026/0044793 A1
(43) Pub. Date: Feb. 12, 2026

(54) SUPPORT METHOD, TERMINAL, SUPPORT SYSTEM, AND CONTROL METHOD

(71) Applicant: Panasonic Intellectual Property Management Co., Ltd., Osaka (JP)

(72) Inventors: Toshihiko KUSAKABE, Osaka (JP); Toshiya Arai, Osaka (JP); Takumi Tonoike, Osaka (JP); Hirokazu Kawamoto, Osaka (JP); Yuki Yamada, Osaka (JP); Shunsuke Kuhara, Osaka (JP)

(21) Appl. No.: 19/361,496

(22) Filed: Oct. 17, 2025

Related U.S. Application Data
(63) Continuation of application No. PCT/JP2024/008248, filed on Mar. 5, 2024.

(30) Foreign Application Priority Data
Apr. 28, 2023 (JP) 2023-074976

(51) Int. Cl. G06Q 10/0631; G06Q 40/12

(52) U.S. Cl. CPC G06Q 10/063112; G06Q 40/125

(57) ABSTRACT

A support method performed by a support system that provides support for an autonomous mobile body includes: receiving request information indicating a request for the support; determining a task relating to the autonomous mobile body by using the request information received; transmitting, to one or more terminals used by one or more supporters, call information indicating a call for one or more workers who perform the task determined; receiving, from a terminal among the one or more terminals, application information indicating an application for the call; and transmitting instruction information indicating an instruction to perform the task to the terminal that has transmitted the application information.

### CROSS REFERENCE TO RELATED APPLICATIONS

This is a continuation application of PCT International Application No. PCT/JP2024/008248 filed on Mar. 5, 2024, designating the United States of America, which is based on and claims priority of Japanese Patent Application No. 2023-074976 filed on Apr. 28, 2023. The entire disclosures of the above-identified applications, including the specifications, drawings and claims are incorporated herein by reference in their entirety.

### FIELD

The present disclosure relates to a support method, a terminal, a support system, and a control method.

### BACKGROUND

A technology has been developed that enables a network computer system to determine measurement standards relating to labor and cost of a delivery task borne by a delivery provider (see Patent Literature (PTL) 1).

### CITATION LIST

### Patent Literature

PTL 1: Japanese Unexamined Patent Application Publication (Translation of PCT Application) No. 2022-509063

### SUMMARY

### Technical Problem

To assign a plurality of tasks including a delivery task to workers, a suitable worker needs to be assigned for each of the plurality of tasks according to details of the task.

In view of this, the present disclosure provides a support method and so forth that support a worker in appropriately performing a task relating to a mobile body.

### Solution to Problem

In accordance with an aspect of the present disclosure, a support method performed by a support system that provides support for an autonomous mobile body includes: receiving request information indicating a request for the support; determining a task relating to the autonomous mobile body by using the request information received; transmitting, to one or more terminals used by one or more supporters, call information indicating a call for one or more workers who perform the task determined; receiving, from a terminal among the one or more terminals, application information indicating an application for the call; and transmitting instruction information indicating an instruction to perform the task to the terminal that has transmitted the application information.

General or specific aspects of the present disclosure may be implemented to a system, a device, a method, an integrated circuit, a computer program, a computer-readable recording medium such as a Compact Disc-Read Only Memory (CD-ROM), or any given combination thereof.

### Advantageous Effects

The support method according to the present disclosure is capable of supporting a worker in appropriately performing a task relating to a mobile body.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating a support system according to Embodiment.

FIG. 2 is a block diagram illustrating a configuration of the support system according to Embodiment.

FIG. 3 is a diagram illustrating an example of task information according to Embodiment.

FIG. 4 is a diagram illustrating an example of supporter information according to Embodiment.

FIG. 5 is a flowchart of processing performed by a management device according to Embodiment.

FIG. 6 is a sequence diagram illustrating a first example of processing performed by the support system according to Embodiment.

FIG. 7 is a diagram illustrating an example of an image displayed on a terminal according to Embodiment.

FIG. 8 is a diagram illustrating an example of an image displayed on the terminal according to Embodiment.

FIG. 9 is a diagram illustrating an example of an image displayed on the terminal according to Embodiment.

FIG. 10 is a sequence diagram illustrating a second example of the processing performed by the support system according to Embodiment.

FIG. 11 is a diagram illustrating an example of an image displayed on the terminal according to Embodiment.

FIG. 12 is a diagram illustrating an example of an image displayed on the terminal according to Embodiment.

FIG. 13 is a diagram illustrating an example of an image displayed on the terminal according to Embodiment.

FIG. 14 is a diagram illustrating an example of an image displayed on the terminal according to Embodiment.

FIG. 15 is a sequence diagram illustrating a third example of the processing performed by the support system according to Embodiment.

FIG. 16 is a sequence diagram illustrating a fourth example of the processing performed by the support system according to Embodiment.

FIG. 17 is a diagram illustrating an example of an image displayed on the terminal according to Embodiment.

FIG. 18 is a diagram illustrating an example of an image displayed on the terminal according to Embodiment.

FIG. 19 is a diagram illustrating an example of an image displayed on the terminal according to Embodiment.

### DESCRIPTION OF EMBODIMENTS

### Underlying Knowledge Forming Basis of the Present Disclosure

In recent years, autonomous mobile bodies (also referred to simply as mobile bodies) have been used to provide services (such as a delivery service, a mobile sales service, a security service, and an advertising service). When a mobile body becomes immobile (also referred to as “stuck”) during such a service, a worker needs to rush to the place (also referred to as the scene) where the mobile body is stuck and needs to restore the mobile body.

For an assumed case where a worker needs to rush to the scene to perform such a task, an appropriate number of workers need to stand by for the task. In addition, it takes some time for the worker to arrive at the scene. During the time taken before the worker arrives at the scene, the service provided by the mobile body may be stopped.

In response to this, a general user may temporarily act as a worker to perform the task relating to the mobile body. Examples of the task relating to the mobile body include a wide variety of tasks, other than the restoration task performed when the mobile body is stuck. The examples include: a maintenance task performed when the mobile body is unable to locate the current position of its own (also referred to as self-position loss) or when the mobile body has a breakdown; and a task of having an interaction with a customer when the mobile body provides the mobile sales of products.

Thus, according to the details of a task relating to the mobile body, the task needs to be assigned to an appropriate number of users each having appropriate skills. When a user having no skills appropriate to the details of the task is assigned to the task or when an inappropriate number of users are assigned to the task, the task relating to the mobile body is not performed appropriately.

The present disclosure provides a support method and so forth that support a worker in appropriately performing a task relating to a mobile body.

The following illustrates the invention obtained from the disclosure of the present specification and describes the advantageous effects achieved by the invention.

(1) A support method performed by a support system that provides support for an autonomous mobile body, the support method including: receiving request information indicating a request for the support; determining a task relating to the autonomous mobile body by using the request information received; transmitting, to one or more terminals used by one or more supporters, call information indicating a call for one or more workers who perform the task determined; receiving, from a terminal among the one or more terminals, application information indicating an application for the call; and transmitting instruction information indicating an instruction to perform the task to the terminal that has transmitted the application information.

According to the above aspect, the support system can instruct the supporter to perform the task, in response to the request for the support from the autonomous mobile body. To instruct the supporter to perform the task, a worker to perform the task relating to the autonomous mobile body is called for and then the worker applies for this call. This enables the support system to instruct an appropriate supporter to perform the task. Thus, the support method can support the supporter in appropriately performing the task relating to the mobile body.

(2) The support method according to (1), wherein in the transmitting of the call information, the call information is transmitted to the one or more terminals that are within a predetermined distance from the autonomous mobile body.

According to the above aspect, the support system transmits the call information to the terminal used by the supporter who is within the predetermined distance from the autonomous mobile body. Thus, the supporter within the predetermined distance from the autonomous mobile body is called for to perform the task relating to the autonomous mobile body and is then instructed to perform the task. This supporter can move to the position of the mobile body and complete the task in a shorter time than a supporter who is at the predetermined distance or more from the mobile body. Thus, this can contribute to downtime reduction of service provided by the autonomous mobile body. Hence, the support method can support the supporter in more quickly performing the task relating to the mobile body.

(3) The support method according to (1), wherein in the transmitting of the call information, the call information is transmitted to at least one terminal used by at least one supporter currently available to perform the task among the one or more supporters, the transmitting being performed based on availability information indicating, for each of the one or more supporters, whether the supporter is currently available to perform the task.

According to the above aspect, the support system transmits the call information to the terminal used by the supporter who is currently available to perform the task. Thus, the supporter who is currently available to perform the task is called for to perform the task relating to the autonomous mobile body and is then instructed to perform the task. This supporter can move to the position of the mobile body and complete the task faster than a supporter who is currently unavailable to perform the task (or more specifically, a supporter who performs the task later). Thus, this can contribute to downtime reduction of service provided by the autonomous mobile body. Hence, the support method can support the supporter in more quickly performing the task relating to the mobile body.

(4) The support method according to (1), wherein in the transmitting of the call information, the call information is transmitted, based on ability information indicating a task ability level for each of the one or more supporters, to at least one terminal used by at least one supporter having the task ability level that satisfies a predetermined condition among the one or more supporters.

According to the above aspect, the support system transmits the call information to the terminal used by the supporter having the task ability that satisfies the predetermined condition. Thus, the supporter having the task ability that satisfies the predetermined condition is called for to perform the task relating to the autonomous mobile body and is then instructed to perform the task. This allows the task relating to the autonomous mobile body to be performed by the supporter having an appropriate task ability. This in turn can contribute to optimization of the task quality. Thus, the support method can support the supporter in appropriately performing the task relating to the mobile body.

(5) The support method according to any one of (1) to (4), wherein the task includes at least one of: a task of securing a moving route for the autonomous mobile body; a task of moving the autonomous mobile body; a task of repairing the autonomous mobile body; or a task of having a remote interaction via the autonomous mobile body.

According to the above aspect, the support system can more easily support the supporter in performing the at least one task relating to the autonomous mobile body.

(6) The support method according to any one of (1) to (5), wherein in the determining, a plurality of tasks are determined, the plurality of tasks each being the task, and in the transmitting of the call information, for each of the plurality of tasks determined, the call information indicating the call for the one or more workers who perform the task is transmitted.

According to the above aspect, the support system determines the plurality of tasks relating to the autonomous mobile body, calls for the workers who perform the plurality of tasks, and issues the instructions to perform the tasks. With this, when a plurality of tasks are required in response to the support request from the autonomous mobile body, the plurality of tasks can be supported. Thus, the support method can support the plurality of supporters in appropriately performing the plurality of tasks relating to the mobile body.

(7) The support method according to any one of (1) to (6), wherein in the receiving, the request information is received from the autonomous mobile body, from a terminal used by an operator who remotely operates the autonomous mobile body, or from a terminal among the one or more terminals used by the one or more supporters.

According to the above aspect, the support system can instruct the supporter to perform the task relating to the autonomous mobile body, in response to the request based on the determination made by the autonomous mobile body, the operator, or the supporter. Furthermore, the support system can more easily instruct the supporter to perform the task. Thus, the support method can more easily support the supporter in appropriately performing the task relating to the mobile body.

(8) The support method according to any one of (1) to (7), wherein in the transmitting of the call information, the call information indicating the call for a plurality of workers as the one or more workers is transmitted.

According to the above aspect, the support system calls for the plurality of workers and issues the instruction to perform the task to the plurality of workers. With this, the support system can instruct the plurality of supporters to perform the task. Thus, the support method can support the plurality of supporters in appropriately performing the task relating to the mobile body.

(9) The support method according to any one of (1) to (8), further comprising: performing provision processing of providing compensation to the one or more workers when report information indicating that the task has been completed is received, the report information being transmitted from the terminal according to the instruction information transmitted.

According to the above aspect, the support system can provide an incentive to the supporter who has performed the task relating to the autonomous mobile body, by providing the compensation. By receiving the incentive in exchange for the execution of the task, the supporter is motivated to perform a new task. This can contribute to an appropriate execution of the new task. Thus, the support method can support the supporter in appropriately performing the task relating to the mobile body.

(10) The support method according to (9), wherein when the one or more workers are a plurality of workers, the provision processing includes processing, to each of the plurality of workers, compensation that is higher as the worker has arrived earlier at a position where the autonomous mobile body is present.

According to the above aspect, as the compensation provided to each of the supporters who have performed the task relating to the autonomous mobile body, the support system provides a higher compensation to the worker who arrives earlier. This can motivate the supporter to arrive earlier when this supporter performs a new task. Thus, the support method can support the supporter in appropriately performing the task relating to the mobile body.

(11) A terminal used by a supporter who provides support for an autonomous mobile body, the terminal including: a controller; and a communication unit connected to the controller, wherein, by using the communication unit, the controller: receives call information indicating a call for one or more workers who perform a task relating to the autonomous mobile body, the task being determined based on request information indicating a request for the support; transmits application information indicating an application for the call indicated in the call information received; and receives instruction information indicating an instruction to perform the task.

According to the above aspect, the terminal achieves the same advantageous effects as those achieved by the support method.

(12) A support system that provides support for an autonomous mobile body, the support system including: a receiver that receives request information indicating a request for the support; a task determiner that determines a task relating to the autonomous mobile body by using the request information received; and a task manager that: transmits, to one or more terminals used by one or more supporters, call information indicating a call for one or more workers who perform the task determined; receives, from a terminal among the one or more terminals, application information indicating an application for the call; and transmits instruction information indicating an instruction to perform the task to the terminal that has transmitted the application information.

According to the above aspect, the support system achieves the same advantageous effects as those achieved by the support method.

(13) A control method performed by a terminal used by a supporter who provides support for an autonomous mobile body, the control method including: receiving call information indicating a call for one or more workers who perform a task relating to the autonomous mobile body, the task being determined based on request information indicating a request for the support; transmitting application information indicating an application for the call indicated in the call information received; and receiving instruction information indicating an instruction to perform the task.

According to the above aspect, the control method achieves the same advantageous effects as those achieved by the support method.

General or specific aspects of the present disclosure may be implemented to a system, a device, a method, an integrated circuit, a computer program, a computer-readable recording medium such as a Compact Disc-Read Only Memory (CD-ROM), or any given combination thereof.

Hereinafter, certain exemplary embodiments will be described in detail with reference to the accompanying Drawings.

The following embodiments are generic or specific examples of the present disclosure. The numerical values, shapes, materials, elements, arrangement and connection configuration of the elements, steps, the order of the steps, etc., described in the following embodiments are merely examples, and are not intended to limit the present disclosure. Among elements in the following embodiments, those not described in any one of the independent claims indicating the broadest concept of the present disclosure are described as optional elements.

### Embodiment

A support system that supports a worker in appropriately performing a task relating to a mobile body is described according to the present embodiment.

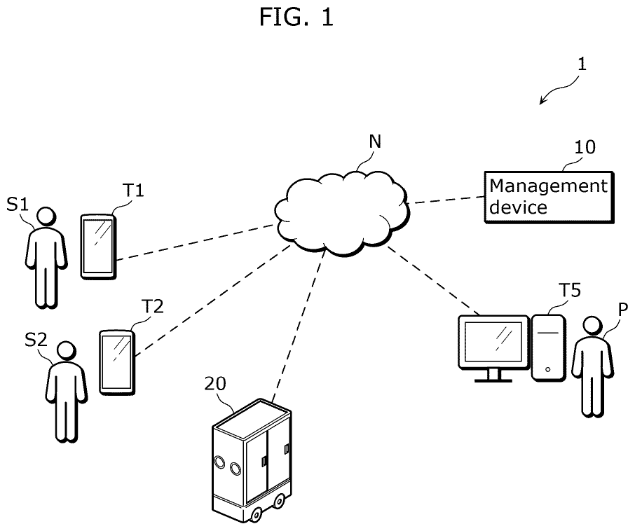

FIG. 1 is a schematic diagram illustrating support system 1 according to the present embodiment. Support system 1 is a system that supports a general user in appropriately performing a task relating to mobile body 20. The general user who performs the task relating to mobile body 20 is also referred to as a supporter (corresponding to supporter S1 or S2 illustrated in FIG. 1). The supporter who performs the task is also referred to as a worker.

As illustrated in FIG. 1, support system 1 includes at least management device 10, and may further include mobile body 20. Note that support system 1 may further include at least one of terminal T1, terminal T2, or terminal T5.

The devices included in support system 1 are communicatively connected via network N. Network N may include a wide area network (such as the Internet or a network of a telecommunications carrier) or a local area network (such as a network within a specific area or within a specific company). Network N may include a wired network or a wireless network.

Management device 10 is a device that performs management to allow the task relating to mobile body 20 to be appropriately performed. Management device 10 is capable of receiving registration of, for example, supporter S1 and presenting a call requesting to perform the task or an instruction to perform the task to supporter S1 who has been registered. Management device 10 may be placed in any physical place where management device 10 can be communicatively connected via network N to, for example, mobile body 20 or terminal T1. Management device 10 may be provided on a so-called cloud server.

Mobile body 20 is an autonomous mobile body (also referred to simply as a mobile body) that provides a service by moving autonomously. Examples of the service provided by mobile body 20 may include a delivery service, a mobile sales service, a security service, and an advertising service. For example, mobile body 20 is a vehicle that drives autonomously, and this case is described by example. However, mobile body 20 is not limited to the aforementioned vehicle and may be a flying body that flies autonomously.

For mobile body 20 to drive or provide a service, a task relating to mobile body 20 may need to be performed by, for example, supporter S1. For example, when mobile body 20 is stuck because of a plant or the like on a route where mobile body 20 is driving, a task of avoiding this plant needs to be performed for mobile body 20. The task performed for mobile body 20 by, for example, supporter S1 to avoid the plant allows mobile body 20 to become unstuck and resume driving.

For example, suppose that mobile body 20 that is autonomously driving based on position information obtained using a global positioning system (GPS) fails to obtain the position information and becomes unable to drive. In this case, a task of moving mobile body 20 to a place where the position information can be obtained using, for example, the GPS needs to be performed. The task performed by, for example, supporter S1 to move mobile body 20 to the place where the position information can be obtained using, for example, the GPS allows mobile body 20 to obtain the position information.

When a task relating to mobile body 20 needs to be performed, mobile body 20 is capable of generating request information indicating a request to perform the task and transmitting the generated request information to management device 10. Furthermore, mobile body 20 is capable of generating position information indicating the current position and transmitting the generated position information to management device 10.

Terminal T1 is a terminal belonging to and used by supporter S1. Terminal T1 functions as a user interface device that transmits, to management device 10, information inputted by supporter S1 and presents supporter S1 with information transmitted from management device 10. An operation performed on terminal T1 by supporter S1 allows terminal T1 to generate request information indicating a request to perform a task and transmit the generated request information to management device 10. Moreover, terminal T1 is capable of generating position information indicating the current position and transmitting the generated position information to management device 10.

Terminal T2 is a terminal belonging to and used by supporter S2. Terminal T2 functions as a user interface device that transmits, to management device 10, information inputted by supporter S2 and presents supporter S2 with information transmitted from management device 10. The configuration of terminal T2 is identical to that of terminal T1 and thus a detailed description thereof is omitted here.

Terminal T5 is a terminal used by operator P. Operator P is a monitor who remotely monitors mobile body 20, and is capable of remotely operating mobile body 20 as needed. For operator P to remotely monitor mobile body 20, video captured by a camera of mobile body 20 or a position or status of mobile body 20 is transmitted from mobile body 20 to terminal T5 via network N.

Terminal T5 displays the aforementioned video or the aforementioned position or status. In the remote monitoring, operator P visually checks the aforementioned video or the aforementioned position or status displayed on terminal T5 and verifies whether mobile body 20 is in a normal status (in other words, whether an anomaly has occurred).

In a remote operation performed on mobile body 20, control information on acceleration, deceleration, or steering of mobile body 20 that is inputted by operator P is transmitted to mobile body 20, and then mobile body 20 is caused to drive in accordance with the control information. In this case, operator P can input the control information on acceleration, deceleration, or steering of mobile body 20 into terminal T5 while visually checking the video captured by camera 22 of mobile body 20 and received by terminal T5 via network N.

Terminal T5 functions as a user interface device that transmits, to management device 10, information inputted by operator P and presents operator P with information transmitted from management device 10. An operation performed on terminal T5 by operator P allows terminal T5 to generate request information indicating a request to perform a task and transmit the generated request information to management device 10.

Note that a total number of supporters, such as supporter S1 and supporter S2, is not limited to two, and may be one or more. Alternatively, the total number may be several thousand or several tens of thousands. Supporter S1 and supporter S2 may be general users or maintenance workers who perform maintenance on mobile body 20. Alternatively, supporter S1 and supporter S2 may include both a general user and a maintenance worker. The maintenance worker is, for example, a person who performs a maintenance task on mobile body 20 as a job. In other words, the maintenance worker is a person who is compensated by performing the maintenance task on mobile body 20. Note that the maintenance worker has a relatively high task ability to perform the maintenance task on mobile body 20. In contrast, the general user may have a high or low task ability to perform the maintenance task on mobile body 20.

Hereafter, configurations of the devices included in support system 1 are described in detail.

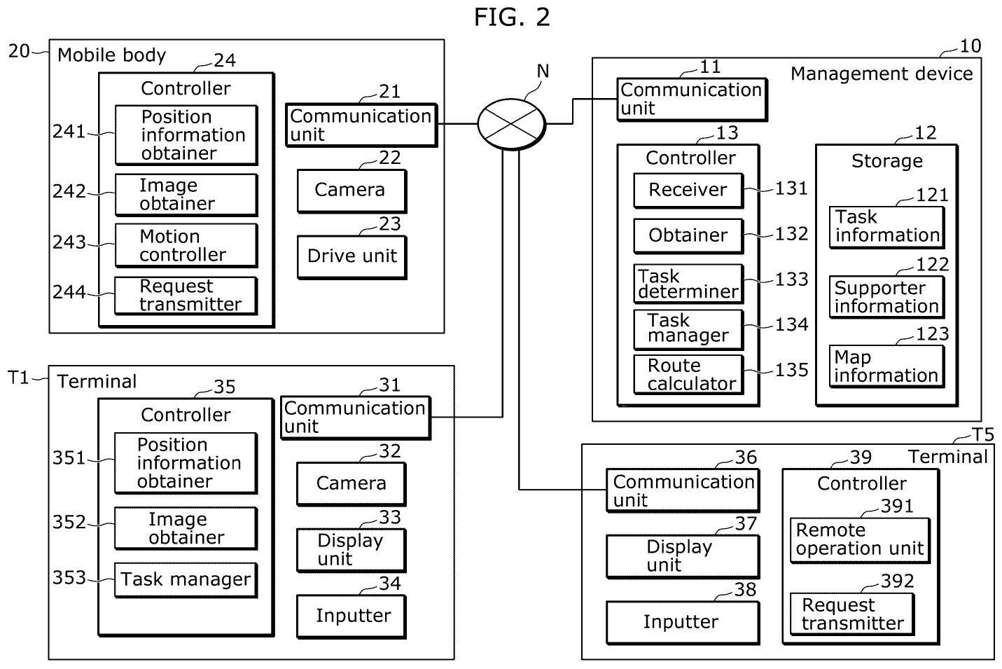

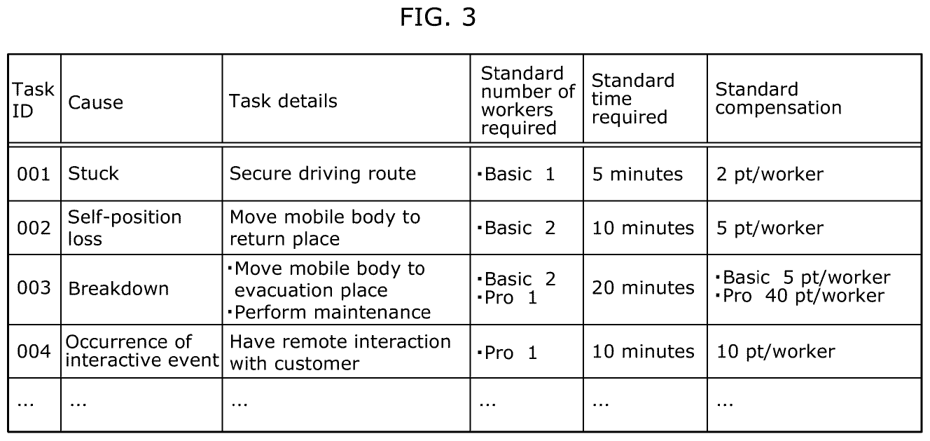

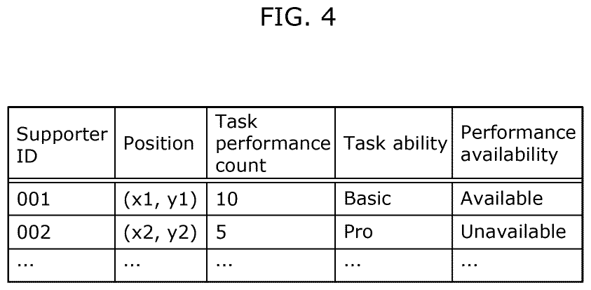

FIG. 2 is a block diagram illustrating a configuration of support system 1 according to the present embodiment. FIG. 3 is a diagram illustrating an example of task information according to the present embodiment. FIG. 4 is a diagram illustrating an example of supporter information according to the present embodiment.

Management device 10 includes communication unit 11, storage 12, and controller 13.

Communication unit 11 is a communication interface that is connected to network N. Communication unit 11 can communicate with terminal T1, terminal T2, terminal T5, or mobile body 20 via network N.

Storage 12 is a storage device that can store information. Storage 12 stores at least task information 121, supporter information 122, and map information 123. Storage 12 may be a volatile storage device, such as a dynamic random access memory (DRAM), or may be a nonvolatile storage device, such as a hard disk drive (HDD) or a solid state drive (SSD).

Task information 121 includes detailed information for each of one or more tasks relating to mobile body 20. Task information 121 is described in detail with reference to FIG. 3.

As illustrated in FIG. 3, task information 121 includes information on “task ID”, “cause”, “task details”, “standard number of workers required”, “standard required time”, and “standard compensation”, for each of the one or more tasks relating to mobile body 20.

“Task ID” is identification information that uniquely identifies the task.

“Cause” is information indicating a cause that necessitates the task.

“Task details” refer to details of the task, and is information indicating the details of the task to be performed by, for example, supporter S1.

“Standard number of workers required” is information indicating a standard number of workers required for the task. Note that the standard number of workers required may indicate a standard number of workers required for the task for each of the task abilities of the supporters including supporter S1. The task ability may be classified as “basic” indicating a standard task ability or as “pro” (professional) indicating a relatively high task ability, for example.

“Standard required time” is information indicating standard time required for the task.

“Standard compensation” is information indicating standard compensation to be provided to, for example, supporter S1 who has performed the task. For example, the compensation is indicated in units of “point” (also indicated by “pt”).

As illustrated by example, the task with task ID 001 is required when mobile body 20 is in a “stuck” situation, and refers to a task of “secure driving route”. As also illustrated, this task requires one supporter who has the “basic” task ability and requires five minutes. Furthermore, the compensation for the task is two points per supporter.

As illustrated by example, the task with task ID 003 is required when mobile body 20 is in a “breakdown” situation, and includes a task of “move mobile body to evacuation place” (also referred to as an evacuation task) and a task of “perform maintenance” (also referred to as a maintenance task). As also illustrated, the evacuation task requires two supporters each of whom has the “basic” task ability, and the maintenance task requires one supporter who has the “pro” task ability. Moreover, the task requires 20 minutes as illustrated. Furthermore, the compensation for the evacuation task is five points per supporter, and the compensation for the maintenance task is 40 points per supporter.

Supporter information 122 includes detailed information for each supporter, such as supporter S1. Supporter information 122 is described in detail with reference to FIG. 4.

As illustrated in FIG. 4, supporter information 122 includes “supporter ID”, “position”, “task performance count”, “task ability”, and “performance availability” for each of one or more supporters. “Supporter ID” is identification information that uniquely identifies the supporter.

“Position” is position information indicating the current position of the supporter. This position can be expressed by coordinates (e.g., latitude and longitude) based on coordinate axes that are appropriately defined.

“Task performance count” is information indicating the number of tasks the supporter has performed.

“Task ability” is information indicating the task ability level of the supporter. This information is also referred to as ability information.

“Performance availability” is information indicating whether the supporter is currently available to perform the task. This information is also referred to as availability information.

As illustrated by example, the supporter with supporter ID 001 is currently located at coordinates (x1, y1), has experienced the task performance ten times, and has the “basic” task ability (that is, the standard task ability). Furthermore, as illustrated, this supporter is currently available to perform the task.

Map information 123 indicates a map of an area in which mobile body 20 drives. Map information 123 includes: an address or name of, for example, a property or facility; and information on a position of and connection to the road. Map information 123 can be used for calculating a driving route for mobile body 20.

Controller 13 controls functions of management device 10 by performing information processing. Controller 13 includes receiver 131, obtainer 132, task determiner 133, task manager 134, and route calculator 135, as functional components. These functional components can be implemented by a processor (e.g., a central processing unit (CPU)) that is included in management device 10 and that executes predetermined programs using a memory.

Receiver 131 receives request information indicating a request to perform a task, via communication unit 11. When receiver 131 receives the request information, this means that receiver 131 receives the request information transmitted from mobile body 20, terminal T5, or terminal T1 of supporter S1, for example. The request information includes identification information for identifying mobile body 20, operator P, or supporter S1, as information for identifying an entity (also referred to as a requester) that requests the task. Furthermore, the request information includes information indicating a cause that necessitates the task. Receiver 131 receives this request information via communication unit 11.

Moreover, receiver 131 is capable of receiving the position information and the performance availability information of, for example, supporter S1 that are transmitted from, for example, terminal T1. When receiver 131 has received the position information and the performance availability information, receiver 131 updates the position information and the performance availability information included in supporter information 122.

Obtainer 132 obtains information on mobile body 20. Specifically, when receiver 131 has received the request information, obtainer 132 obtains at least the position information and the status information of mobile body 20. The position information of mobile body 20 indicates the current position of mobile body 20. The status information of mobile body 20 indicates the current status of mobile body 20 (such as driving, stationary, or providing a service).

Furthermore, obtainer 132 is capable of obtaining surrounding information of surroundings of mobile body 20 in the above case. The surrounding information may include an image that is captured by camera 22 of mobile body 20 and that shows a view of the surroundings of mobile body 20. Furthermore, the surrounding information may include scene information obtained by, for example, supporter S1 who is in the vicinity of mobile body 20. The scene information includes: an image that is captured by camera 32 of terminal T1 of supporter S1 who is in the vicinity of mobile body 20 and that shows mobile body 20; or textual information inputted by supporter S1 in terminal T1 to indicate the appearance of mobile body 20 or the look of the surroundings of mobile body 20.

Task determiner 133 determines a task relating to mobile body 20. The task determined by task determiner 133 is a task that relates to mobile body 20 and that needs to be performed by, for example, supporter S1. Specifically, by reference to task information 121, task determiner 133 determines the task relating to mobile body 20, based on the request information received by receiver 131 and the information on mobile body 20 obtained by obtainer 132.

The task determined by task determiner 133 can include at least one of: a task of securing a driving route for mobile body 20; a task of moving mobile body 20; a task of repairing mobile body 20; or a task of having a remote interaction via mobile body 20. The task determined by task determiner 133 may include a plurality of tasks among the aforementioned tasks.

Furthermore, task determiner 133 calculates an amount of labor required (the number of workers required and the required time) for the task determined.

Specifically, when the request information received by receiver 131 includes “stuck” as the cause and the position information of mobile body 20 obtained by obtainer 132 indicates that mobile body 20 is stationary and not moving, task determiner 133 determines the task of “secure driving route” corresponding to the cause of “stuck” in task information 121. Moreover, task determiner 133 calculates that this task requires one supporter who has the “basic” task ability and also requires “5 minutes”.

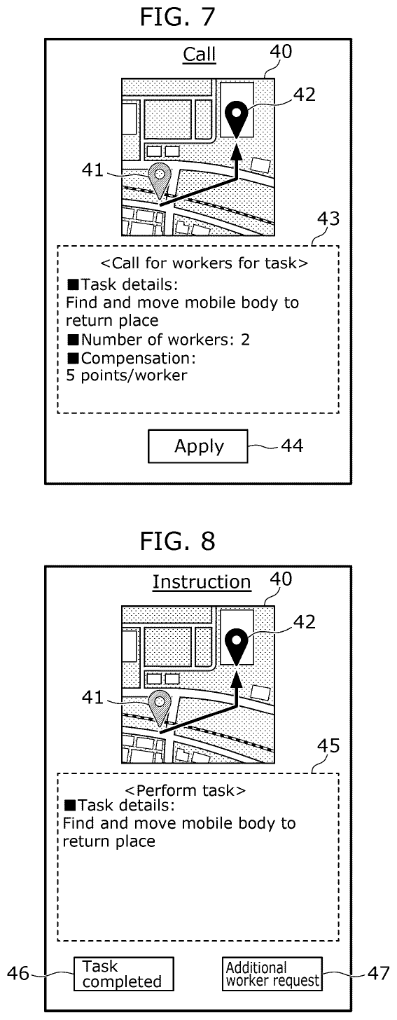

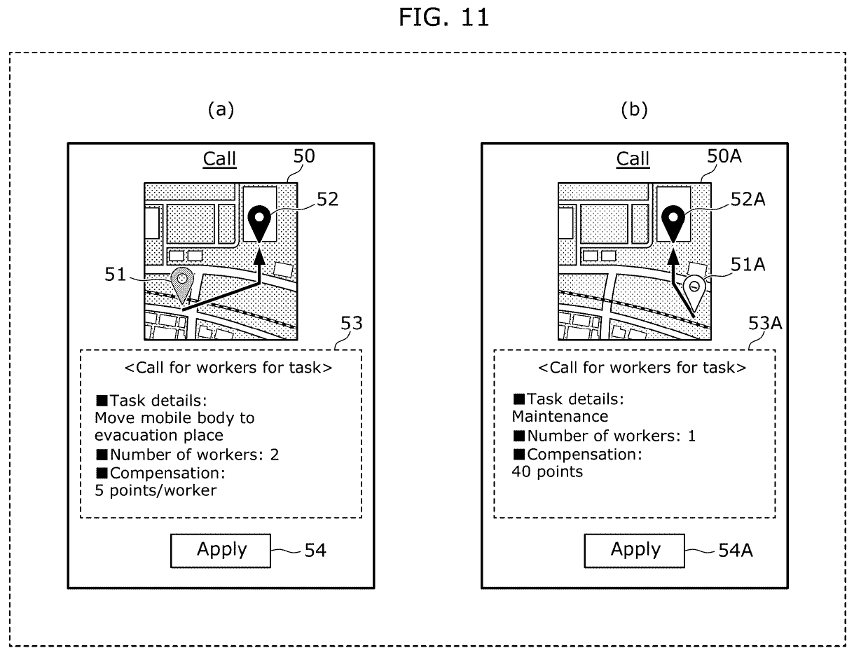

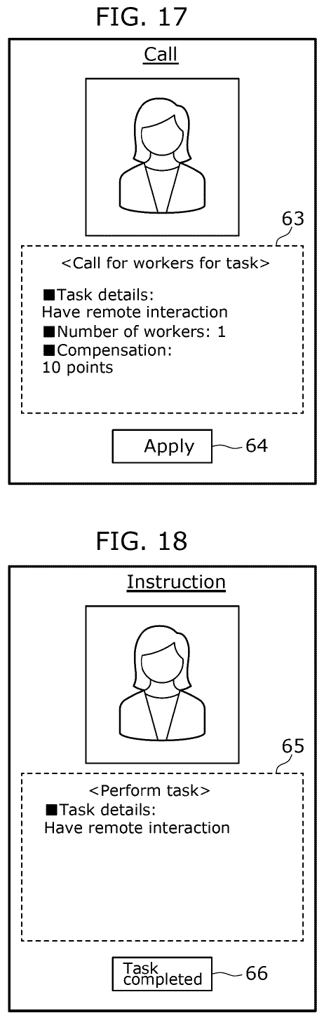

Task manager 134 manages call, application, and instruction to perform the task relating to mobile body 20. Task manager 134 determines a worker who performs the task relating to mobile body 20 from among the one or more supporters and provides an instruction to perform the task to the worker. Specifically, task manager 134 transmits, via communication unit 11, call information for calling for one or more workers who perform the task determined by task determiner 133, to one or more terminals used by the supporters included in supporter information 122 (in other words, the terminals used by the one or more supporters). The one or more workers targeted for the call may be a plurality of workers. The call information includes at least: position information indicating a position where the worker is to perform the task; details of the task; the number of workers required for the task; and compensation information. Specific examples of the call information are illustrated in FIG. 7, FIG. 11, and FIG. 17 described later.

When transmitting the call information, task manager 134 may transmit the call information to at least one terminal used by at least one supporter among the one or more supporters, instead of transmitting the call information to all the terminals used by the one or more supporters included in supporter information 122. In other words, task manager 134 may keep the call information from being transmitted to a terminal other than the at least one terminal used by the at least one supporter among the one or more supporters included in supporter information 122.

For example, task manager 134 may transmit the call information to, for example, the at least one terminal such as terminal T1 used by the at least one supporter such as supporter S1 who is within a predetermined distance from the current position of mobile body 20 among the one or more supporters. In this case, task manager 134 calculates a separation distance between the current position of mobile body 20 and each of the current positions of the supporters including supporter S1 indicated in supporter information 122. Then, task manager 134 transmits the call information to the at least one terminal such as terminal T1 used by the at least one supporter such as supporter S1 having the separation distance less than or equal to a predetermined distance, among the plurality of terminals including terminal T1.

Task manager 134 may transmit the call information to the at least one terminal used by the at least one supporter who is available to perform the task as indicated in the performance availability information, among the one or more supporters. In this case, task manager 134 transmits the call information to the at least one terminal such as terminal T1 used by the at least one supporter such as supporter S1 who is currently available to perform the task as indicated in the performance availability information in supporter information 122, among the plurality of terminals including terminal T1.

Task manager 134 may transmit the call information to the at least one terminal used by the at least one supporter who has the task ability level that satisfies a predetermined condition in the ability information, among the one or more supporters. Examples of the predetermined condition include “only basic”, “only pro”, and “basic or pro”. In this case, task manager 134 transmits the call information to the at least one terminal such as terminal T1 used by the at least one supporter such as supporter S1 who has the task ability that satisfies the predetermined condition as indicated in supporter information 122, among the plurality of terminals including terminal T1.

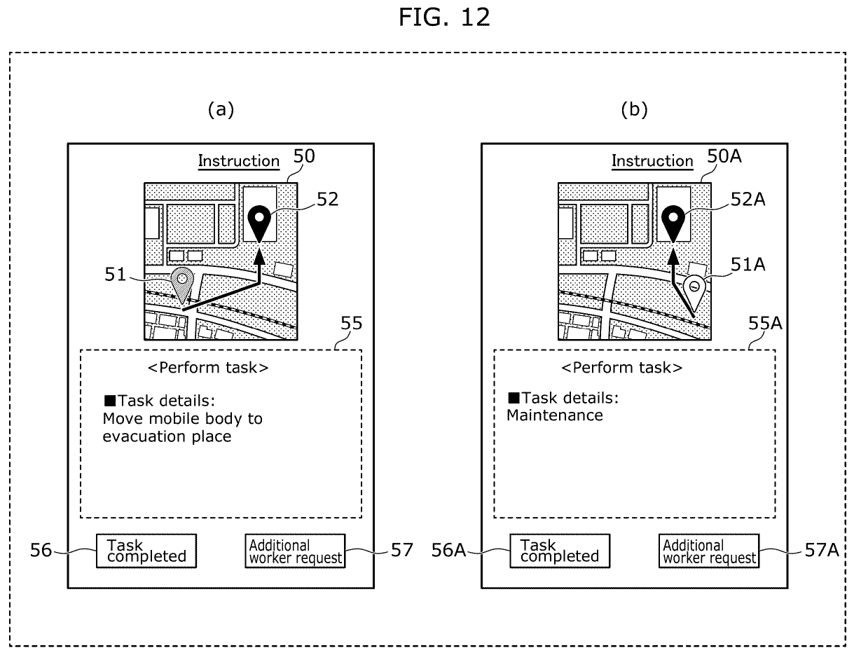

Furthermore, task manager 134 receives, via communication unit 11, application information indicating an application for the call from, for example, terminal T1 that has received the call information. When the application information has been received, obtainer 132 transmits instruction information indicating an instruction to perform the task to, for example, terminal T1 that has transmitted the application information. The instruction information includes at least: position information indicating a position where a supporter (or more specifically, a worker) who has received the instruction information is to perform the task; and details of the task. This position information may include route information on a route to be taken by the supporter from the current position to the scene where mobile body 20 is present. Specific examples of the instruction information are illustrated in FIG. 8, FIG. 12, and FIG. 18 described later.

Note that when the number of pieces of application information received (that is, the number of supporters including supporter S1 who have applied for the call) is greater than the number of workers called for (also referred to as the number of called-for workers), task manager 134 selects terminals including terminal T1 as many as the called-for workers from terminals having transmitted the pieces of application information received. Then, task manager 134 transmits the instruction information to the selected terminals including terminal T1. The terminals including terminal T1 as many as the called-for workers may be selected from among the terminals that have transmitted the application information received, in the order of earlier transmission time of the application information, for example.

Furthermore, task manager 134 receives report information from, for example, terminal T1. The details of the report information include at least one of “task completed” or “additional worker request”. When the details of the report information indicate “task completed”, task manager 134 performs completion processing. The completion processing includes provision processing of providing the compensation to, for example, supporter S1 who is the worker having performed the task. The provision processing includes: deposit processing of depositing money corresponding to the compensation to a bank account of supporter S1; or information processing of providing supporter S1 with value information corresponding to the compensation (such as money or information having a value equivalent to money).

When the one or more workers are a plurality of workers, the provision processing may include processing of providing different compensation for each of the plurality of workers. For example, the provision processing may include processing of providing higher compensation to a worker who has performed a larger workload (in other words, who has made a greater contribution to the support) among the plurality of workers. In this case, task manager 134 can obtain the workload (or a degree of contribution) for each of the plurality of workers and calculate the compensation for each of the plurality of workers based on the obtained workload. The workload (or the degree of contribution to the support) for each of the plurality of workers can be obtained through determination made by a staff member who is at the scene where mobile body 20 is present and who is in charge of operation or maintenance of mobile body 20. The provision processing may include processing of providing compensation to each worker such that the compensation is higher as the worker has arrived earlier at the scene where mobile body 20 is present. In this case, a time of arrival at the scene of mobile body 20 can be obtained for each of the plurality of workers, from the position information of the terminal. Task manager 134 can obtain the time of arrival at the scene of mobile body 20 for each of the plurality of workers and calculate the compensation for each of the plurality of workers based on the obtained time of arrival. When the aforementioned staff member in charge is at the scene of mobile body 20, this staff member determines the time of arrival at the scene for each of the plurality of workers. Thus, the compensation can be calculated for each of the plurality of workers, based on the time obtained from this staff member.

Furthermore, the completion processing includes update processing of updating task information 121. The update processing is performed when the standard number of workers required or the standard required time indicated in task information 121 is determined to be substantially different from the actual number of workers or the actual time that has been required for the task. In this case, the standard number of workers required or the standard required time included in task information 121 is updated in accordance with the actual number of workers or the actual time that has been required for the task. Assume for example that although the standard number of workers required indicated in task information 121 is one, the actual number of workers required was two. In this case, task manager 134 can update the standard number of workers required indicated in task information 121 to two.

Note that the completion processing may include processing of: transmitting, to terminal T1 for example, information indicating that the aforementioned completion processing or update processing is about to be performed or has been performed; and causing terminal T1 to display this information.

Route calculator 135 calculates a driving route for mobile body 20. The driving route calculated by route calculator 135 is used for calculating, for example, the route information included in the instruction information (in other words, the route information on the route taken by, for example, supporter S1 to reach the scene).

Mobile body 20 includes communication unit 21, camera 22, drive unit 23, and controller 24.

Communication unit 21 is a communication interface that is connected to network N. Communication unit 21 can communicate with management device 10 via network N.

Camera 22 is an imaging device that images a view of the surroundings. For example, camera 22 is mounted on the enclosure body of mobile body 20 in a position to face forward, backward, or to the side of mobile body 20.

Drive unit 23 includes: wheels that are driven to allow mobile body 20 to move; and a steering mechanism that changes a steering angle of the wheels. Moreover, drive unit 23 may include: a power source (a battery or an engine) for rotating the wheels; and fuel.

Controller 24 controls functions of mobile body 20 by performing information processing. Controller 24 includes position information obtainer 241, image obtainer 242, motion controller 243, and request transmitter 244, as functional components. These functional components can be implemented by a processor (e.g., a CPU) that is included in mobile body 20 and that executes predetermined programs using a memory.

Position information obtainer 241 obtains position information indicating the current position of mobile body 20. Position information obtainer 241 obtains the position information indicating the current position of mobile body 20 using, for example, the GPS. Position information obtainer 241 can transmit the obtained position information to management device 10 via communication unit 21.

Image obtainer 242 uses camera 22 to generate an image showing a forward, backward, or side view as seen from mobile body 20. The image generated by image obtainer 242 can be provided to motion controller 243 to be used for autonomous driving of mobile body 20. Moreover, the image generated by image obtainer 242 is transmitted to terminal T5 via communication unit 21 to be used for remote monitoring or remote operation performed on mobile body 20. Alternatively, the image is transmitted to management device 10 via communication unit 21 to be used as the surrounding information for determining the task.

Motion controller 243 controls the autonomous driving of mobile body 20. Specifically, motion controller 243 calculates the position of mobile body 20 by performing image processing on the image generated by camera 22. Moreover, motion controller 243 calculates the driving route for mobile body 20 by using the calculated position of mobile body 20. Furthermore, to cause mobile body 20 to drive along the calculated driving route, motion controller 243 generates control information for controlling acceleration, deceleration, or steering of mobile body 20 and provides the control information to drive unit 23. As a result, the autonomous driving of mobile body 20 is controlled.

Request transmitter 244 transmits request information when a task relating to mobile body 20 is determined to be required. For example, request transmitter 244 transmits the request information when position information obtainer 241 has been unable to obtain the position information for a predetermined period of time (e.g., about five to ten minutes) (in other words, in the event of self-position loss). In this case, information for identifying the requester included in the request information is the identification information of mobile body 20 and the cause indicated in the request information is “self-position loss”.

Terminal T1 includes communication unit 31, camera 32, display unit 33, inputter 34, and controller 35. For example, terminal T1 is a smartphone or a tablet terminal, and this case is described by example. Note that terminal T1 may be a personal computer.

Communication unit 31 is a communication interface that is connected to network N. Communication unit 31 can communicate with management device 10 via network N.

Camera 32 is an imaging device that images a view of the surroundings.

Display unit 33 is a display device that displays an image. Display unit 33 displays an image relating to image data provided by controller 35. Display unit 33 is a liquid crystal display or an organic electro-luminescence (organic EL), for example.

Inputter 34 is an input device that receives information inputted by, for example, supporter S1. Inputter 34 is a touch panel, a touch pad, a keyboard, or a mouse, for example.

Controller 35 controls functions of terminal T1 by performing information processing. Controller 35 includes position information obtainer 351, image obtainer 352, and task manager 353, as functional components. These functional components can be implemented by a processor (e.g., a CPU) that is included in terminal T1 and that executes predetermined programs using a memory.

Position information obtainer 351 obtains position information indicating the current position of terminal T1. Position information obtainer 351 obtains the position information indicating the current position of terminal T1 using, for example, the GPS.

Image obtainer 352 uses camera 32 to capture a view of the surroundings of terminal T1 and generates an image showing the view of the surroundings. Image obtainer 352 can generate an image showing mobile body 20 when supporter S1 who has terminal T1 uses camera 32 to capture the image in the vicinity of mobile body 20.

Task manager 353 manages call, application, and instruction to perform the task relating to mobile body 20. Specifically, task manager 353 receives call information from management device 10. When task manager 353 has received the call information from management device 10, task manager 353 displays details of a call indicated in the call information on display unit 33. When task manager 353 has received, from inputter 34, an operation indicating an application from supporter S1 for the call indicated in the call information received from mobile body 20, task manager 353 transmits application information indicating this application to mobile body 20 via communication unit 31. Moreover, task manager 353 receives instruction information from mobile body 20. When task manager 353 has received the instruction information from mobile body 20, task manager 353 displays details of an instruction indicated in the instruction information on display unit 33.

Moreover, task manager 353 transmits report information to management device 10. The details of the report information include at least one of “task completed” or “additional worker request”. “Task completed” indicates that supporter S1 has performed the task indicated in the instruction information and has completed the task. “Additional worker request” indicates a request for an increase in worker. For example, when supporter S1 has determined that the number of workers for performing the task indicated in the instruction information is insufficient, the additional worker request is transmitted based on an operation performed by supporter S1.

Note that task manager 353 can transmit the request information when a task relating to mobile body 20 is required. For example, based on that supporter S1 has determined the task relating to mobile body 20 is required, task manager 353 can transmit the request information. In this case, information for identifying the requester included in the request information is the identification information of terminal T1.

Terminal T5 includes communication unit 36, display unit 37, inputter 38, and controller 39.

Communication unit 36 is a communication interface that is connected to network N. Communication unit 36 can communicate with management device 10 via network N.

Display unit 37 is a display device that displays an image. Display unit 37 displays an image relating to image data provided by controller 39. Display unit 37 is a liquid crystal display or an organic

EL, for example.

Inputter 38 is an input device that receives information inputted by operator P. Inputter 38 is a touch panel, a touch pad, a keyboard, or a mouse, for example.

Controller 39 controls functions of terminal T5 by performing information processing. Controller 39 includes remote operation unit 391 and request transmitter 392, as functional components. These functional components can be implemented by a processor (e.g., a CPU) that is included in terminal T5 and that executes predetermined programs using a memory.

Remote operation unit 391 performs processing relating to remote monitoring and remote operation performed on mobile body 20. Remote operation unit 391 performs the processing relating to the remote monitoring, by receiving video captured by camera 22 of mobile body 20 or the position or status of mobile body 20 via communication unit 36 and causing display unit 37 to display the received video or the received position or status. Moreover, by transmitting, to mobile body 20 via communication unit 36, the control information on acceleration, deceleration, or steering of mobile body 20 that is inputted by operator P, remote operation unit 391 can cause mobile body 20 to drive in accordance with this control information (in other words, can remotely operate mobile body 20).

Request transmitter 392 transmits request information when a task relating to mobile body 20 is determined to be required. For example, when mobile body 20 is determined to have a breakdown, request transmitter 392 transmits the request information. In this case, information for identifying the requester included in the request information is the identification information of terminal T5 and the cause indicated in the request information is “breakdown”.

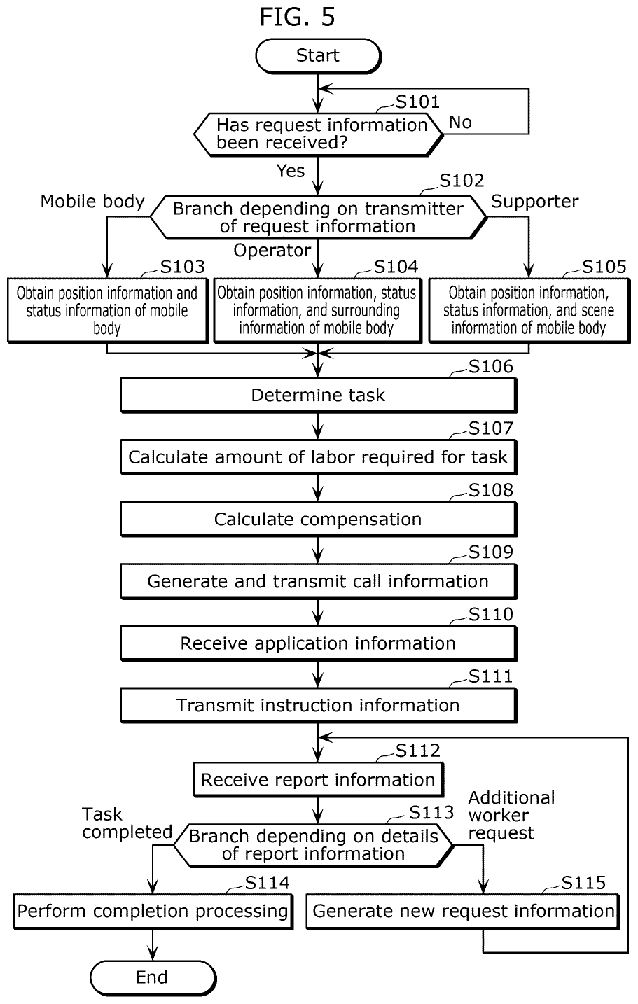

FIG. 5 is a flowchart of processing performed by management device 10 according to the present embodiment.

Assume that the supporter information of supporter S1 and supporter S2 has been registered in management device 10 at the time of execution of step S101.

In step S101, receiver 131 determines whether the request information has been received. When receiver 131 determines that the request information has been received (Yes in step S101), receiver 131 proceeds to step S102. Otherwise (No in step S101), receiver 131 executes step S101 again. Specifically, receiver 131 waits at step S101 until the request information is received.

In step S102, obtainer 132 branches the processing, depending on the transmitter of the request information received in step S101. When the transmitter of the request information is determined to be mobile body 20 (“Mobile body” in step S102), obtainer 132 proceeds to step S103. When the transmitter of the request information is determined to be operator P (“Operator” in step S102), obtainer 132 proceeds to step S104. When the transmitter of the request information is determined to be, for example, supporter S1 (“Supporter” in step S102), obtainer 132 proceeds to step S105.

In step S103, obtainer 132 obtains, from mobile body 20, the position information and the status information of mobile body 20. Note that obtainer 132 may transmit, to mobile body 20, request information for requesting for the position information and the status information. Then, obtainer 132 may obtain the position information and the status information transmitted from mobile body 20 in response to this request information. Alternatively, obtainer 132 may obtain the position information and the status information transmitted autonomously from mobile body 20.

In step S104, obtainer 132 obtains the position information, the status information, and the surrounding information of mobile body 20 from terminal T5. Note that obtainer 132 may transmit, to terminal T5, request information for requesting for the position information, the status information, and the surrounding information. Then, obtainer 132 may obtain the position information, the status information, and the surrounding information transmitted from terminal T5 in response to this request information. Alternatively, obtainer 132 may obtain the position information, the status information, and the surrounding information transmitted autonomously from terminal T5.

In step S105, obtainer 132 obtains the position information, the status information, and the scene information of mobile body 20 from terminal T1. Note that obtainer 132 may transmit, to terminal T1, request information for requesting for the position information, the status information, and the scene information. Then, obtainer 132 may obtain the position information, the status information, and the scene information transmitted from terminal T1 in response to this request information. Alternatively, obtainer 132 may obtain the position information, the status information, and the scene information transmitted autonomously from terminal T1.

In step S106, by reference to task information 121, task determiner 133 determines the task relating to mobile body 20 that needs to be performed by the supporter, based on the information obtained in step S103, S104, or S105.

In step S107, task manager 134 calculates the amount of labor required for the task determined in step S106. By reference to task information 121, task manager 134 calculates the amount of labor based on the task details, the standard number of workers required, and the standard required time. The amount of labor includes the number of workers required and the required time.

In step S108, task manager 134 calculates the compensation to be paid to the worker who is the supporter and who has performed the task determined in step S106. By reference to task information 121, task manager 134 calculates the compensation based on the task details, the standard number of workers required, the standard required time, and the standard compensation.

In step S109, task manager 134 generates call information and transmits the call information to the one or more supporters.

In step S110, task manager 134 receives application information. The received application information is transmitted from, for example, terminal T1 that has received the call information transmitted from task manager 134 in step S109. Here, one or more pieces of application information may be received. The application information indicates that, for example, supporter S1 who has seen the call indicated in the call information on terminal T1 applies for this call. Task manager 134 waits for a predetermined period of time after transmitting the call information in step S109 and can receive the aforementioned application information while waiting. Note that when no application information has been received during the predetermined period of time, task manager 134 may terminate the sequence of processes illustrated in FIG. 5.

In step S111, task manager 134 transmits instruction information to, for example, terminal T1 that has transmitted the application information received in step S110. Note that when the number of pieces of application information received in step S110 is greater than the number of called-for workers, task manager 134 selects the terminals including terminal T1 as many as the called-for workers and transmits the aforementioned instruction information to the selected terminals including terminal T1.

Terminal T1, for example, receives the instruction information and then displays the received instruction information on display unit 33. The displayed instruction information is assumed to be visually checked by supporter S1. Supporter S1 who has visually checked the instruction information moves to the position of mobile body 20 and performs the task, in accordance with the instruction information.

Note that authentication of supporter S1 may be performed when supporter S1 arrives at the scene where mobile body 20 is present. The authentication is performed by determining whether terminal T1 has authentication information generated by management device 10, for example. The authentication information may include identification information for uniquely identifying the task that needs to be performed by, for example, supporter S1.

Specifically, to perform the authentication, management device 10 generates authentication information and transmits this authentication information to terminal T1. Terminal T1 displays the received authentication information on display unit 33 and causes camera 22 of mobile body 20 to capture this authentication information. Mobile body 20 transmits an image showing the captured authentication information to management device 10. Management device 10 determines whether the authentication information shown in the received image matches the authentication information that has been transmitted from management device 10. Then, when the shown authentication information is determined to match the transmitted authentication information, management device 10 authenticates supporter S1. The authentication information may be textual information or an image (such as a quick-response (QR) code (registered trademark)).

In step S112, task manager 134 receives report information. The received report information is transmitted from, for example, terminal T1 that has received the instruction information transmitted from task manager 134 in step S111. Task manager 134 waits for a predetermined period of time after transmitting the instruction information in step S111 and can receive the aforementioned report information while waiting. Note that when no report information has been received during the predetermined period of time, task manager 134 may terminate the sequence of processes illustrated in FIG. 5.

Note that when mobile body 20 has a function of transmitting report information, task manager 134 may receive this report information from mobile body 20.

In step S113, task manager 134 branches the processing depending on the details of the report information received in step S112. When the details of the report information are determined to indicate “task completed” (“Task completed” in step S113), task manager 134 proceeds to step S114. When the details of the report information are determined to indicate “additional worker request” (“Additional worker request” in step S113), task manager 134 proceeds to step S115.

In step S114, task manager 134 performs the completion processing. After step S114, task manager 134 ends the sequence of processes illustrated in FIG. 5.

In step S115, task manager 134 generates a new piece of request information. To generate the new piece of request information, task manager 134 proceeds to step S112 to continue the processing. Then, in parallel with this processing, task manager 134 performs the sequence of processes illustrated in FIG. 5 for the new received request information in a new processing unit (or more specifically, a process or thread managed by the processor). Here, the aforementioned sequence is performed in response to the receipt of the new request information, assuming that the supporter has transmitted this request information.

By the sequence of processes illustrated in FIG. 5, support system 1 supports the worker in appropriately performing the task relating to mobile body 20.

The following describes processing performed by support system 1 for possible specific tasks (1) to (4) below.

### (1) Case Where Mobile Body 20 Suffers Self-Position Loss While Driving

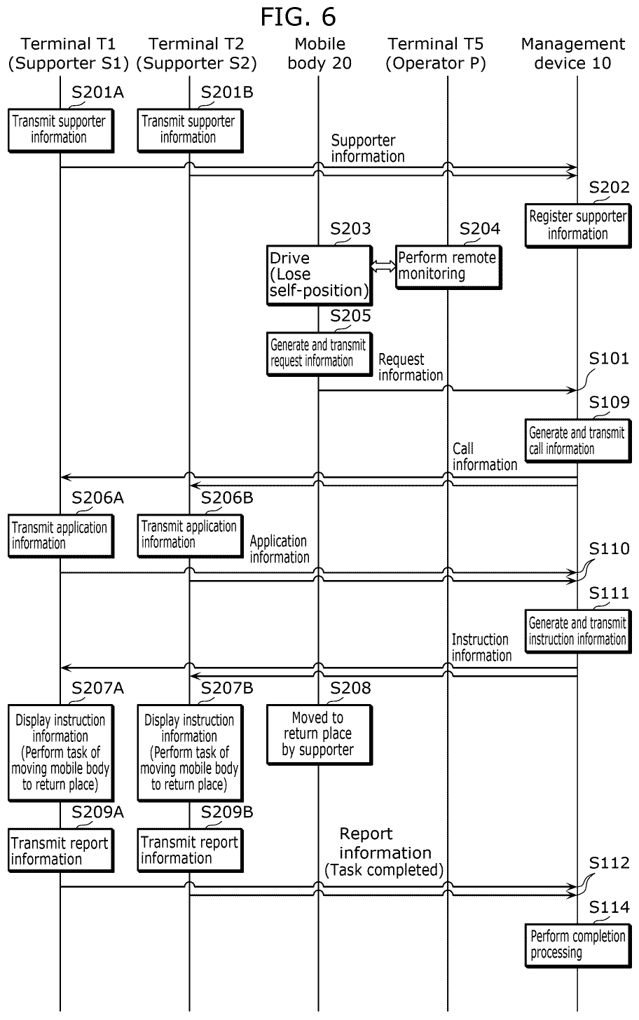

FIG. 6 is a sequence diagram illustrating processing performed by support system 1 according to the present embodiment. FIG. 7 to FIG. 9 are diagrams illustrating examples of an image displayed on a terminal according to the present embodiment. Note that processes performed by management device 10 illustrated in FIG. 6 that are identical to those illustrated in FIG. 5 are assigned the same reference signs as in FIG. 5 and detailed descriptions thereof are omitted.

In this example, after registering supporters S1 and S2 as supporters, management device 10 calls for two supporters to perform a task.

In step S201A, terminal T1 transmits supporter information indicating supporter S1 to management device 10. Management device 10 receives the supporter information transmitted.

In step S201B, terminal T2 transmits supporter information indicating supporter S2 to management device 10. Management device 10 receives the supporter information transmitted.

In step S202, management device 10 registers the supporter information indicating supporter S1 that is received in step S201A and the supporter information indicating supporter S2 that is received in step S201B, in supporter information 122.

In step S203, mobile body 20 suffers the self-position loss while autonomously driving.

In step S204, operator P remotely monitors, by using terminal T5, mobile body 20 that is autonomously driving.

In step S205, mobile body 20 generates and transmits request information to management device 10 due to the self-position loss in step S203. The cause indicated in the request information generated by mobile body 20 is “self-position loss” and the transmitter of the request information is mobile body 20. Management device 10 (receiver 131) receives the request information transmitted (step S101), and obtains the position information and the status information of mobile body 20 (step S103). Then, management device 10 determines that the task needed to be performed by the supporter is to “move mobile body to return place”. Moreover, management device 10 generates call information relating to the determined task, and transmits the generated call information to terminals T1 and T2 (step S109). Terminals T1 and T2 receive the call information transmitted.

In step S206A, terminal T1 transmits application information in response to the receipt of the call information transmitted in step S109. For example, terminal T1 displays the received call information as an image on display unit 33 (see FIG. 7). As illustrated in FIG. 7, the displayed call information includes map image 40 indicating the position of mobile body 20, information 43 indicating the task relating to mobile body 20, and button image 44. Map image 40 includes mark 41 indicating the position of terminal T1 and mark 42 indicating the position of mobile body 20, for example. Information 43 includes the task details, the number of called-for supporters, and compensation information, for example. Button image 44 indicates an operation button for receiving an operation indicating that supporter S1 applies for this call. When supporter S1 who visually checks the call information operates button image 44 with the intention of applying for the call, task manager 353 receives this operation and transmits the application information. Management device 10 receives the application information transmitted (step S110).

In step S206B, terminal T2 transmits application information in response to the receipt of the call information transmitted in step S109. Terminal T2 can transmit the application information through processing similar to the processing performed by terminal T1 in step S206A. Management device 10 receives the application information transmitted (step S110).

In step S111, management device 10 (task manager 134) transmits instruction information to terminals T1 and T2 that have transmitted the application information received in step S110. Each of terminals T1 and T2 receives the instruction information transmitted.

In step S207A, terminal T1 displays the instruction information received in step S111, as an image on display unit 33 (see FIG. 8). As illustrated in FIG. 8, the displayed instruction information includes map image 40 indicating the position of mobile body 20 and information 45 indicating the task relating to mobile body 20. Map image 40 is identical to map image 40 illustrated in FIG. 7. Information 45 includes at least the task details out of information 43 illustrated in FIG. 7. Information 43 illustrated in FIG. 7 may be used as information 45.

Moreover, terminal T1 may display button images 46 and 47 together with the instruction information. Button image 46 indicates an operation button for receiving an operation indicating that supporter S1 has completed the task indicated in the instruction information. Button image 47 indicates an operation button for receiving an operation indicating that supporter S1 requests for additional worker.

Supporter S1 visually checks the instruction information displayed on terminal T1. Then, supporter S1 performs the task of moving mobile body 20 to the return place in accordance with the instruction information.

In step S207B, terminal T2 displays the instruction information received in step S111, as an image on display unit 33. The image displayed on terminal T2 is identical to the image displayed on terminal T1 in step S207A.

Supporter S2 visually checks the instruction information displayed on terminal T2. Then, supporter S2 performs the task of moving mobile body 20 to the return place in accordance with the instruction information.

In step S208, mobile body 20 is moved to the return place by supporters S1 and S2 in accordance with the instruction information displayed on terminal T1 in step S207A and on terminal T2 in step S207B. This enables mobile body 20 to obtain its self-position, or more specifically, the self-position loss occurred in step S203 is solved.

In step S209A, terminal T1 transmits report information to management device 10. The details of the report information indicate “task completed”. In response to the receipt of the report information transmitted, management device 10 performs the completion processing (Step S114). Terminal T1 may transmit the report information in response to an operation performed by supporter S1 on button image 46 displayed in step S207A. Management device 10 receives the report information transmitted.

In step S209B, terminal T2 transmits the report information to management device 10. The process performed by terminal T2 to transmit the report information to management device 10 is identical to the process (step S209A) performed by terminal T1 to transmit the report information to management device 10. Management device 10 receives the report information transmitted.

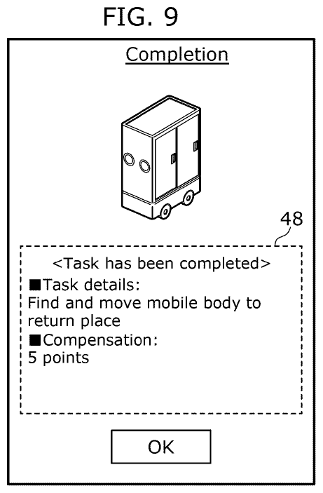

Management device 10 performs the completion processing according to the receipt of the report information in steps S209A and S209B (step S114). For example, management device 10 transmits information indicating the completion of the task to terminals T1 and T2 to display this information on display units 33 of terminals T1 and T2 (see FIG. 9). As illustrated in FIG. 9, the information indicating the completion of the task includes information 48 indicating the completion of the task relating to mobile body 20. Information 48 includes the task details and the compensation, for example.

By the sequence of processes illustrated in FIG. 6, management device 10 can support supporters S1 and S2 in appropriately performing the task of moving mobile body 20 to the return place to solve the self-position loss of mobile body 20 when mobile body 20 suffers the self-position loss while driving. As a result, management device 10 can solve the self-position loss of mobile body 20.

### (2) Case Where Mobile Body 20 Stops Due to Breakdown While Driving

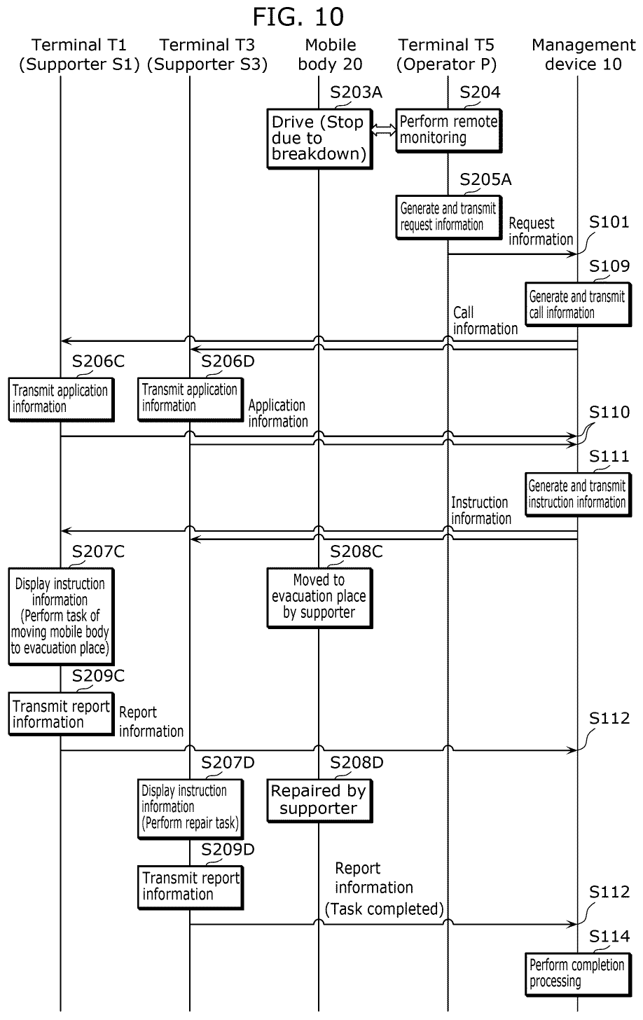

FIG. 10 is a sequence diagram illustrating processing performed by support system 1 according to the present embodiment. FIG. 11 to FIG. 14 are diagrams illustrating examples of an image displayed on a terminal according to the present embodiment. Note that processes performed by management device 10 illustrated in FIG. 10 that are identical to those illustrated in FIG. 5 are assigned the same reference signs as in FIG. 5 and detailed descriptions thereof are omitted.

In this example, supporters S1, S2, and S3 have been registered as supporters, and management device 10 calls for three supporters to perform tasks. In the call for the three workers, workers with different task abilities are called for to perform two tasks relating to mobile body 20.

The two tasks relating to mobile body 20 are to “move mobile body to evacuation place” and to “perform maintenance”. Each of the task abilities of supporters S1 and S2 is “basic” and the task ability of supporter S3 is “pro”. Note that actions of supporter S2 are the same as those of supporter S1, and that processes of terminal T2 are the same as those of terminal T1. Thus, descriptions and illustrations of supporter S2 and terminal T2 may be omitted.

FIG. 10 illustrates processes to be performed after the processes for registration of the supporter information (steps S201A, S201B, and S202 in FIG. 6).

In step S203A, mobile body 20 stops due to a breakdown while autonomously driving.

In step S204, operator P remotely monitors, by using terminal T5, mobile body 20 that is autonomously driving.

In step S205A, terminal T5 generates and transmits request information to management device 10 in response to a stop of mobile body 20 due to a breakdown. An operation performed by operator P who is monitoring allows terminal T5 to generate the request information. The cause indicated in the request information generated by terminal T5 is “breakdown” and the transmitter of the request information is operator P. Management device 10 (receiver 131) receives the request information transmitted (step S101), and obtains the position information, the status information, and the surrounding information of mobile body 20 (step S104). Then, management device 10 determines that the tasks needed to be performed by the supporters are to “move mobile body to evacuation place” (also referred to as the evacuation task) and to “perform maintenance” (also referred to as the maintenance task). Moreover, management device 10 generates call information relating to the evacuation task and transmits the generated call information to terminals T1 and T2, and furthermore generates call information relating to the maintenance task and transmits the generated call information to terminal T3 (step S109). Terminals T1, T2, and T3 receive the call information transmitted.

In step S206C, terminal T1 transmits application information in response to the receipt of the call information transmitted in step S109. For example, terminal T1 displays the received call information as an image on display unit 33 (see (a) of FIG. 11). As illustrated in (a) of FIG. 11, the displayed call information includes map image 50 indicating the position of mobile body 20, information 53 indicating the task relating to mobile body 20, and button image 54. Map image 50 includes mark 51 indicating the position of terminal T1 and mark 52 indicating the position of mobile body 20, for example. The aforementioned images and information are identical to the respective corresponding images and information with the same descriptions in FIG. 7. In step S206C, terminal T2 transmits application information as with terminal T1.

In step S206D, terminal T3 transmits application information in response to the receipt of the call information transmitted in step S109. For example, terminal T3 displays the received call information as an image on display unit 33 (see (b) of FIG. 11). As illustrated in (b) of FIG. 11, the displayed call information includes map image 50A indicating the position of mobile body 20, information 53A indicating the task relating to mobile body 20, and button image 54A. Map image 50A includes mark 51A indicating the position of terminal T3 and mark 52A indicating the position of mobile body 20, for example. The aforementioned images and information are identical to the respective corresponding images and information with the same descriptions in FIG. 7.

In step S111, management device 10 (task manager 134) transmits instruction information to terminals T1, T2, and T3 that have transmitted the application information received in step S110. Each of terminals T1, T2, and T3 receives the instruction information transmitted.

In step S207C, terminal T1 displays the instruction information received in step S111, as an image on display unit 33 (see (a) of FIG. 12). As illustrated in (a) of FIG. 12, the displayed instruction information includes map image 50 indicating the position of mobile body 20 and information 55 indicating the task relating to mobile body 20. Map image 50 is identical to map image 50 illustrated in (a) of FIG. 11. Information 55 includes at least the task details out of information 53 illustrated in (a) of FIG. 11. Information 53 illustrated in (a) of FIG. 11 may be used as information 55.

Moreover, terminal T1 may display button images 56 and 57 together with the instruction information. Button image 56 and button image 57 are identical, respectively, to button image 46 and button image 47 illustrated in FIG. 8.

Supporter S1 visually checks the instruction information displayed on terminal T1. Then, supporter S1 performs the evacuation task after moving to the position of mobile body 20, in accordance with the instruction information.

Similarly, terminal T2 displays the instruction information on display unit 33. Supporter S2 visually checks the instruction information displayed on terminal T2. Then, supporter S2 performs the evacuation task after moving to the position of mobile body 20, in accordance with the instruction information.

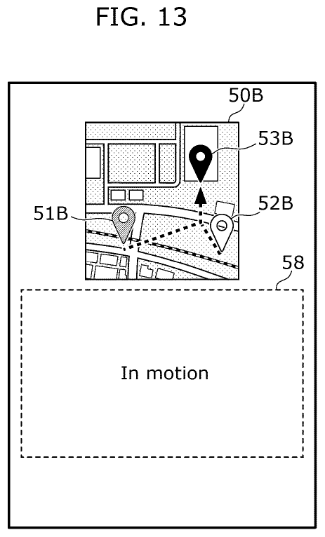

Note that while supporter S1 is moving to the position of mobile body 20, terminal T1 may display, on display unit 33, an image showing that each of the supporters including supporter S1 is in motion (see FIG. 13). The image showing that each of the supporters including supporter S1 is in motion includes map image 50B and information 58 that indicates each of the supporters including supporter S1 is in motion, for example. Map image 50B includes mark 51B indicating the position of terminal T1, mark 52B indicating the position of terminal T3, and mark 53B indicating the position of mobile body 20, for example. Information 58 includes a character string of “in motion”, for example. Note that although display of a mark indicating the position of terminal T2 is omitted from FIG. 13, the mark indicating the position of terminal T2 may be displayed.

In step S208C, mobile body 20 is moved to the evacuation place by supporters S1 and S2 in accordance with the instruction information displayed on terminals T1 and T2 in step S207C. The evacuation place may be a place predetermined as a relatively safe place (e.g., a relatively large space adjacent to the road). In the evacuation place, maintenance (also referred to as repair) may be performed on mobile body 20.

In step S209C, terminal T1 transmits report information to management device 10. The details of the report information indicate “task completed”.

In step S207D, terminal T3 displays the instruction information received in step S111, as an image on display unit 33 (see (b) of FIG. 12). As illustrated in (b) of FIG. 12, the displayed instruction information includes map image 50A indicating the position of mobile body 20 and information 55A indicating the task relating to mobile body 20. Map image 50A is identical to map image 50A illustrated in (b) of FIG. 11. Information 55A includes at least the task details out of information 53A illustrated in (b) of FIG. 11. Information 53A illustrated in (b) of FIG. 11 may be used as information 55A.

Moreover, terminal T3 may display button images 56A and 57A together with the instruction information. Button image 56A and button image 57A are identical, respectively, to button image 46 and button image 47 illustrated in FIG. 8.

Supporter S3 visually checks the instruction information displayed on terminal T3. Then, supporter S3 performs the maintenance task (also referred to as the repair task) on mobile body 20 in accordance with the instruction information.

In step S208D, mobile body 20 is repaired by supporter S3 in accordance with the instruction information displayed on terminal T3 in step S207D. As a result, the broken state of mobile body 20 is fixed.

In step S209D, terminal T3 transmits report information to management device 10. The details of the report information indicate “task completed”.

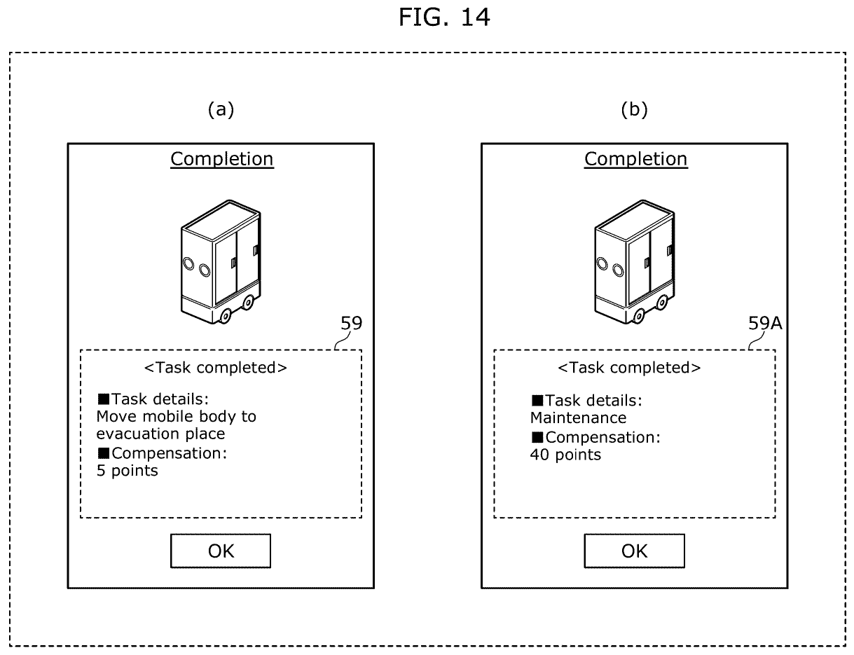

Management device 10 performs the completion processing according to receipt of the report information in steps S209C and S209D (step S114). For example, management device 10 transmits information indicating the completion of the task to terminals T1, T2, and T3 to display this information on display units 33 of terminals T1 and T2 (see (a) of FIG. 14) and on display unit 33 of terminal T3 (see (b) of FIG. 14). Information 59 indicating the completion of the task as displayed on terminals T1 and T2 includes the task details and the compensation, for example. Information 59A indicating the completion of the task as displayed on terminal T3 includes the task details and the compensation, for example.

By the sequence of processes illustrated in FIG. 10, management device 10 can support supporters S1 and S2 in appropriately performing the evacuation task and also support supporter S3 in appropriately performing the maintenance task when mobile body 20 has a breakdown while driving.

Note that although FIG. 10 illustrates an example in which the call information relating to the two tasks are transmitted at the same time (step S109), the call information may be transmitted at different times. When the two tasks are the task of “move mobile body to evacuation place” and the task of “perform maintenance”, the task of “perform maintenance” is assumed to be performed after the task of “move mobile body to evacuation place”. On this account, the call information for the task of “perform maintenance” may be transmitted after the call information for the task of “move mobile body to evacuation place” is transmitted.

Note that although FIG. 10 illustrates that terminal T3 displays the instruction information (step S207D) after terminal T1 displays the instruction information (step S207C), terminals T1 and T3 may display the instruction information at the same time.

### (3) Case Where Mobile Body 20 is Stuck While Driving

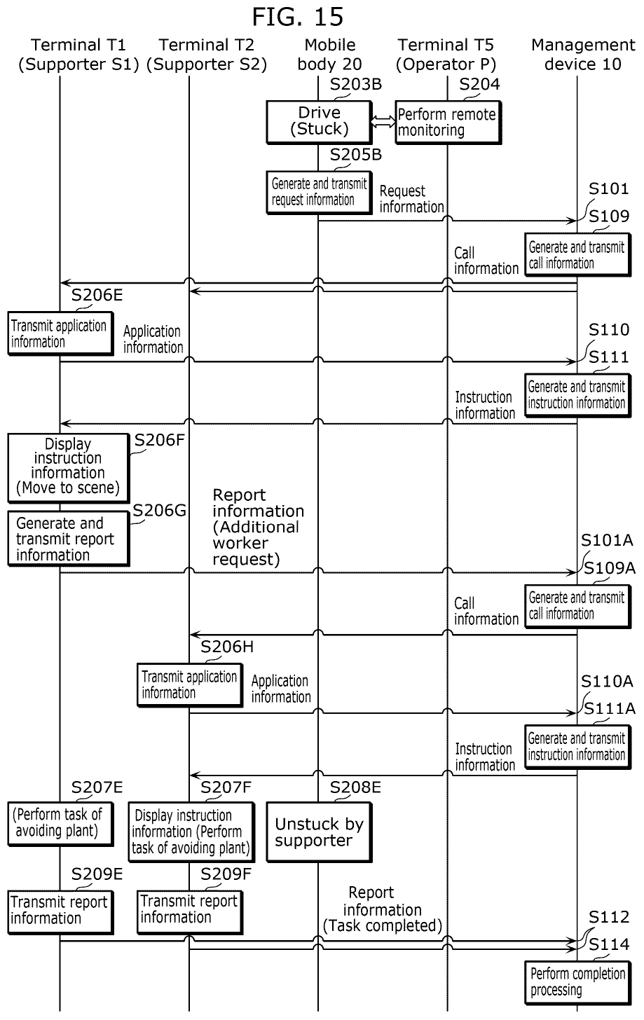

FIG. 15 is a sequence diagram illustrating processing performed by support system 1 according to the present embodiment. Note that processes performed by management device 10 illustrated in FIG. 15 that are identical to those illustrated in FIG. 5 are assigned the same reference signs as in FIG. 5 and detailed descriptions thereof are omitted.

In this example, supporters S1 and S2 have been registered as supporters, and an additional worker request is made after one supporter is called for. Thus, this example describes that a task is performed by two supporters eventually.

FIG. 15 illustrates processes to be performed after the processes for registration of the supporter information (steps S201A, S201B, and S202 in FIG. 6).

In step S203B, mobile body 20 is stuck due to a plant while autonomously driving.

In step S204, operator P remotely monitors, by using terminal T5, mobile body 20 that is autonomously driving.

In step S205B, mobile body 20 generates and transmits request information to management device 10 in response to being stuck. The cause indicated in the request information generated by mobile body 20 is “stuck” and the transmitter of the request information is mobile body 20. Management device 10 (receiver 131) receives the request information transmitted (step S101), and obtains the position information, the status information, and the surrounding information of mobile body 20 (step S104). Then, management device 10 determines that the task relating to mobile body 20 that needs to be performed by the supporter is to “avoid plant”. Moreover, management device 10 generates call information relating to the determined task and transmits the generated call information to terminals T1 and T2 (step S109). Terminals T1 and T2 receive the call information transmitted.

In step S206E, terminal T1 transmits application information in response to the receipt of the call information transmitted in step S109. Management device 10 receives the application information transmitted (step S110). For example, terminal T1 displays the received call information as an image on display unit 33. The displayed call information corresponds to the call information illustrated in FIG. 7 in which the task details are replaced with “avoid plant” and the number of workers is replaced with “1”.

In this case, only terminal 1 transmits the application information and terminal T2 does not transmit the application information.

In step S111, management device 10 (task manager 134) transmits instruction information to terminal T1 that has transmitted the application information received in step S110. Terminal T1 receives the instruction information transmitted.

In step S206F, terminal T1 displays the instruction information received in step S111, as an image on display unit 33 (not shown). The displayed instruction information corresponds to, for example, the instruction information illustrated in FIG. 8 in which the task details are replaced with “avoid plant”. Supporter S1 visually checks the instruction information displayed on terminal T1 and then moves to the scene where mobile body 20 is present.

In step S206G, terminal T1 generates and transmits report information to management device 10. The details of the report information indicate “additional worker request”. The report information can be generated through an operation performed on terminal T1 by supporter S1 when supporter S1 checks the situation of mobile body 20 at the scene and then determines that only one worker (that is, supporter S1) is insufficient to perform the task indicated in the instruction information (that is, the task of avoiding the plant).

In response to the receipt of the report information transmitted (step S101, indicated as step S101A in FIG. 15), management device 10 redetermines a task that is needed to be performed by the supporter, generates call information relating to the determined task, and transmits the generated call information to terminal T2 (step S109, indicated as step S109A in FIG. 15).

In step S206H, terminal T2 transmits application information in response to the receipt of the call information transmitted in step S109A. Management device 10 receives the application information transmitted (step S110, indicated as step S110A in FIG. 15).

In step S111A, management device 10 (task manager 134) transmits instruction information to terminal T2 that has transmitted the application information received in step S110A. Terminal T2 receives the instruction information transmitted.

In step S207F, terminal T2 displays the instruction information received in step S111A, as an image on display unit 33 (not shown). The displayed instruction information corresponds to, for example, the instruction information illustrated in FIG. 8 in which the task details are replaced with “avoid plant”. Supporter S2 visually checks the instruction information displayed on terminal T2 and then moves to the scene. After this, supporters S1 and S2 perform the task of avoiding the plant (step S207E).

In step S208E, mobile body 20 becomes unstuck through the task performed by supporters S1 and S2 to avoid the plant in accordance with the instruction information displayed on terminal T1 in step S207E and on terminal T2 in step S207F.

In step S209E, terminal T1 transmits report information to management device 10. The details of the report information indicate “task completed”.

In step S209F, terminal T2 transmits report information to management device 10. The details of the report information indicate “task completed”.

In response to the receipt of the report information transmitted in step S209E and step S209F, management device 10 performs the completion processing (step S114).

By the sequence of processes illustrated in FIG. 15, when mobile body 20 becomes stuck while driving, management device 10 can support in appropriate execution of the task of making mobile body 20 unstuck, by using the additional worker request.

### (4) Case Where Interactive Event Occurs During Sales Service by Mobile Body 20

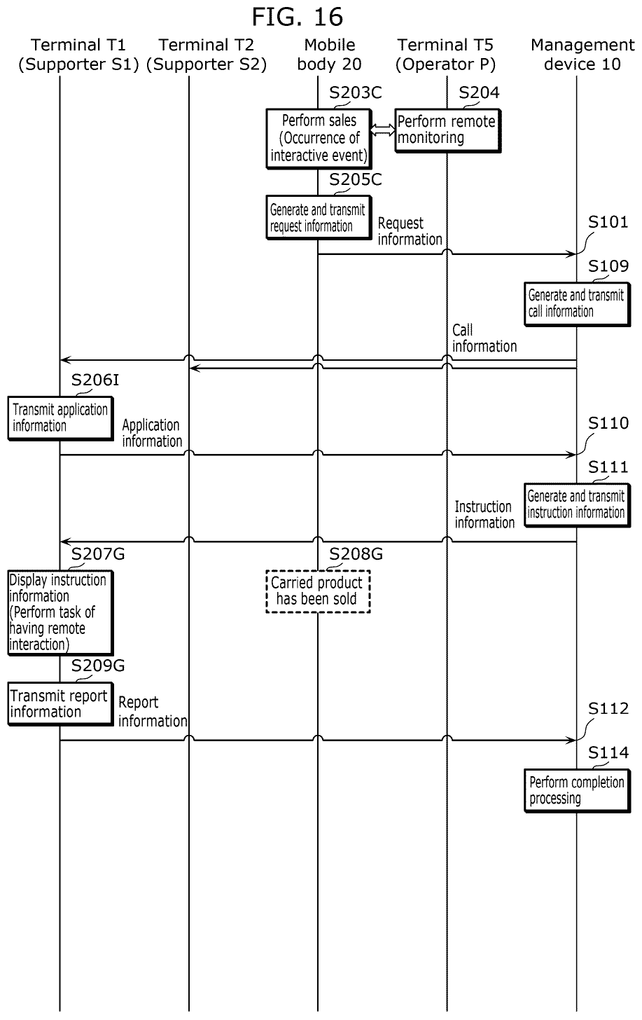

FIG. 16 is a sequence diagram illustrating processing performed by support system 1 according to the present embodiment. FIG. 17 to FIG. 19 are diagrams illustrating examples of an image displayed on a terminal according to the present embodiment. Note that processes performed by management device 10 illustrated in FIG. 16 that are identical to those illustrated in FIG. 5 are assigned the same reference signs as in FIG. 5 and detailed descriptions thereof are omitted.

In this example, supporters S1 and S2 have been registered as supporters, and one supporter is called for to perform a task.

FIG. 16 illustrates processes to be performed after the processes for registration of the supporter information (steps S201A, S201B, and S202 in FIG. 6).

In step S203C, an interactive event occurs when mobile body 20 is selling products as service provision. For example, the interactive event occurs when a customer performs an operation (e.g., a button press) on mobile body 20 to request for product description and then mobile body 20 receives this operation.

In step S204, operator P remotely monitors, by using terminal T5, mobile body 20 that is conducting sales.

In step S205C, mobile body 20 generates and transmits request information to management device 10 in response to the occurrence of the interactive event. The cause indicated in the request information generated by mobile body 20 is “occurrence of interactive event” and the transmitter of the request information is mobile body 20. Management device 10 (receiver 131) receives the request information transmitted (step S101), and obtains the position information, the status information, and the surrounding information of mobile body 20 (step S104). Then, management device 10 determines that the task relating to mobile body 20 that needs to be performed by the supporter is to “have remote interaction with customer”. Moreover, management device 10 generates call information relating to the determined task and transmits the generated call information to terminals T1 and T2 (step Terminals T1 and T2 receive the call information S109). transmitted.

In step S2061, terminal T1 transmits application information in response to the receipt of the call information transmitted in step S109. For example, terminal T1 displays the received call information as an image on display unit 33 (see FIG. 17). As illustrated in FIG. 17, the displayed call information includes information 63 indicating the task relating to mobile body 20 and button image 64. The aforementioned images and information are identical to the respective corresponding images and information with the same descriptions in FIG. 7. Management device 10 receives the application information transmitted (step S110).

In step S111, management device 10 (task manager 134) transmits instruction information to terminal T1 that has transmitted the application information received in step S110. Terminal T1 receives the instruction information transmitted.

In step S207G, terminal T1 displays the instruction information received in step S111, as an image on display unit 33 (see FIG. 18). As illustrated in FIG. 18, the displayed instruction information includes information 65 indicating the task relating to mobile body 20. Information 65 includes at least the task details out of information 63 illustrated in FIG. 17. Information 63 illustrated in FIG. 17 may be used as information 65.

Moreover, terminal T1 may display button image 66 together with the instruction information. Button image 66 is identical to button image 46 illustrated in FIG. 8.

Supporter S1 visually checks the instruction information displayed on terminal T1. Then, supporter S1 performs the task of having a remote interaction in accordance with the instruction information. The task performed by supporter S1 to have the remote interaction may lead to a sale of a product carried in mobile body 20 (step S208G).

In step S209G, terminal T1 transmits report information to management device 10. The details of the report information indicate “task completed”.

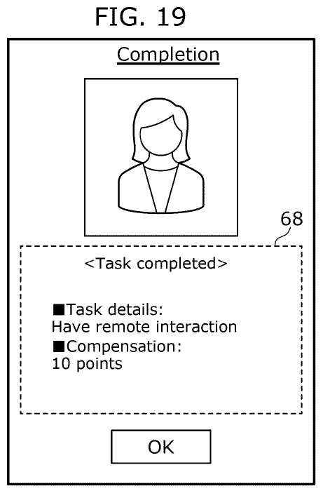

Management device 10 performs the completion processing in response to the receipt of the report information in step S209G (step S114). For example, management device 10 transmits information indicating the completion of the task to terminal T1 to display this information on display unit 33 of terminal T1 (see FIG. 19). Information 68 indicating the completion of the task as displayed on terminal T1 includes the task details and the compensation, for example.

By the sequence of processes illustrated in FIG. 16, management device 10 can support supporter S1 in appropriately performing the task of having a remote interaction when the interactive event occurs to mobile body 20.

### Variations

The following describes variations of the above-described Embodiment.

### Example 1

When management device 10 generates the call information (step S109 (see FIG. 5)), management device 10 may generate the call information that includes an urgency level of the task or a completion deadline for the task. Moreover, management device 10 may generate the call information indicating that higher compensation is provided for a worker who completes the task faster. In this case, the task information (see FIG. 3) includes information indicating: the urgency level of the task or the completion deadline for the task; or that higher compensation is provided for faster task completion. By reference to this information, management device 10 can generate the aforementioned call information. This enhances the motivation of the worker to complete the task faster and also increases opportunities for support system 1 to be used. As a result, the support provided by support system 1 leads to more tasks relating to mobile body 20 for workers to perform. This contributes to more appropriate service being provided by mobile body 20.

### Example 2

When management device 10 generates the call information (step S109 (see FIG. 5)), management device 10 may generate the call information in which the compensation is corrected to a higher amount at a time of day when fewer supporters are present. This increases the probability of application from supporters in response to the call information and also increases opportunities for support system 1 to be used. As a result, the support provided by support system 1 leads to more tasks relating to mobile body 20 for workers to perform. This contributes to more appropriate service being provided by mobile body 20.

### Example 3

When management device 10 generates the call information (step S109 (see FIG. 5)), management device 10 may transmit the call information to a general user among the supporters when a predetermined condition is determined to be satisfied. However, when the predetermined condition is determined not to be satisfied, the call information need not be transmitted to the general user among the supporters (in other words, this transmission may be restricted). The transmission of the call information to the general user among the supporters increases the cost (increases the cost corresponding to the compensation to be paid to the general user, for example). Thus, the restriction on the transmission of the call information to the general user among the supporters can reduce the increase of the aforementioned cost.

Specifically, the predetermined condition includes at least one of the following.
A condition that a request indicated in the request information is to perform the task that is urgently necessary and also that this task needs to be performed as soon as possible.
A condition that if a maintenance worker moves from the current position to the scene of mobile body 20, this requires more man-hours, cost, and time than the respective standards.
A condition that a maintenance worker is unable to immediately head to the scene of mobile body 20.

### Example 4

When management device 10 generates and transmits the call information to the supporter (step S109 (see FIG. 5)), management device 10 may also request the task by sending a notice to those who are in the vicinity of mobile body 20.

For example, when the request indicated in the request information is a request to perform the task that is urgently necessary, management device 10 may generate and transmit the call information and also send the notice to those who are in the vicinity of mobile body 20. Note that when a person in the vicinity of mobile body 20 performs the task on mobile body 20, the call information may indicate that the task indicated in the call information may be cancelled. Moreover, the compensation for the worker who has performed the task indicated in this call information may be set relatively higher (e.g., higher than the standard compensation).

When the person in the vicinity of mobile body 20 has performed the task after the worker was instructed to perform this task indicated in the call information, the task indicated in the call information is cancelled and the terminal used by the worker receives notification about this cancellation. In this case, no compensation is provided for the worker. Note that when the worker has already been heading to the scene of mobile body 20, the compensation corresponding to a distance traveled by the worker may be provided for the worker.

Note that when a person (e.g., a person in the vicinity of mobile body 20) other than the worker has performed the task, management device 10 can perform processing of providing compensation for the person who has performed the task. For example, management device 10 displays, on the display screen of mobile body 20, a QR code encoding a uniform resource locator (URL) for compensation processing. Then, the compensation processing can be performed when the terminal possessed by the person who has performed the task reads the displayed QR code to access the aforementioned URL. Note that, in this case, the QR code may be displayed through information processing performed by mobile body 20, instead of through the control by management device 10.

Note that when the request indicated in the request information is a request to perform the task that is not urgently necessary, management device 10 need not send the notice to those who are in the vicinity of mobile body 20 (in other words, this sending may be restricted).

Note that when a supporter is called for to perform a task, a notice requesting the task need not be sent to those who are in the vicinity of mobile body 20 when the supporter is a general user.

### Example 5

When management device 10 has requested a task by generating and transmitting the call information to a supporter and also by sending a notice to those who are in the vicinity of mobile body 20, management device 10 may determine whether the supporter has performed the task as a worker or a person in the vicinity of mobile body 20 has performed the task. When the person in the vicinity of mobile body 20 has performed the task, the compensation in exchange for the task need not be provided for the supporter (in other words, the compensation may be prohibited from being provided for the supporter). However, the compensation corresponding to the distance traveled by the supporter may be provided as in Example 4 above. In this way, the supporter who has not performed the task is prevented from receiving the compensation provided in exchange for the task. Thus, the support provided by support system 1 leads to more tasks relating to mobile body 20 for workers to perform. This contributes to more appropriate service being provided by mobile body 20.

In relation to the aforementioned determination, suppose that a length of time between an arrival time of the supporter as the worker at the scene of mobile body 20 and a reception time of the report information is determined to be, for example, significantly shorter than a planned task period (such as when a difference between these times is shorter than about half of the planned task period), for example. In this case, the person in the vicinity of mobile body 20 is determined to have performed the task. This is because the task can be assumed to have been completed before the supporter performs the task.

In relation to the aforementioned determination, suppose that the position of mobile body 20 at an arrival time of the supporter as the worker at the scene of mobile body 20 suffering the self-position loss is the same as the position of mobile body 20 at a reception time of the report information by management device 10, for example. In this case, the person in the vicinity of mobile body 20 is determined to have performed the task. This is because the task can be assumed to have been completed before the supporter performs the task.

In relation to the aforementioned determination, suppose that the current position of the supporter as the worker at a time of the task completion is determined not to be in the proximity of the position of mobile body 20 (e.g., within about 5 m to 20 m), for example. In this case, the person in the vicinity of mobile body 20 is determined to have performed the task. This is because the supporter can be assumed not to have performed the task when the supporter is not in the proximity of mobile body 20 at the time of the task completion. This is premised on that mobile body 20 has the function of transmitting the report information (step S112 (see FIG. 5)).

### Example 6

When management device 10 receives the application information (step S110 (see FIG. 5), a plurality of reception periods may be set at intervals. During the plurality of reception periods, the call information generated in step S109 may be transmitted. This can increase opportunities for supporters to see the call indicated in the call information and help to increase the number of pieces of the application information to be received by management device 10. Thus, this in turn contributes to more appropriate service being provided by mobile body 20.

### Example 7

When management device 10 transmits the instruction information (step S111 (see FIG. 5)), the terminals as many as the called-for workers may be selected based on the task ability or the task performance count of each supporter. For example, the terminals as many as the called-for workers can be selected by selecting the terminals as many as the called-for workers who have relatively high task abilities. Alternatively, the terminals as many as the called-for workers can be selected by selecting the terminals as many as the called-for workers who have relatively high task performance counts. This is because a worker having a higher task performance count is assumed to have higher skills.

### Example 8

When management device 10 transmits the instruction information (step S111 (see FIG. 5)), the terminals as many as the called-for worker are selected. In this case, when a plurality of consecutive tasks need to be performed on mobile body 20, the terminal used by the supporter who is able to perform the plurality of consecutive tasks may be selected preferentially. This is because when each of the tasks is performed by a different worker, the completion of all the tasks may be delayed due to, for example, time wasted in switching the workers between the tasks.

For example, in “(2) Case where mobile body 20 stops due to breakdown while driving” according to the present embodiment described above, the two assumed tasks that need to be performed by the supporter are the evacuation task and the maintenance task. To request to perform the evacuation task and the maintenance task, management device 10 may generate and transmit, to the terminal, the call information including a call for the worker to perform both the evacuation task and the maintenance task. The terminal that receives the call information displays an image of the call information that includes both the image of the call information illustrated in (a) of FIG. 11 and the image of the call information illustrated in (b) of FIG. 11.

### Example 9

When management device 10 transmits the instruction information (step S111 (see FIG. 5)), a plurality of terminals as many as the called-for workers are selected, that is, a plurality of supporters are selected as a plurality of workers. In this case, the terminal used by one worker may receive and display information on a different worker. For example, the terminal used by the one worker among the plurality of workers may receive, from the different worker among the plurality of workers, an estimated time of arrival of the different worker at the position of mobile body 20. Then, the received estimated time may be displayed on this terminal. Moreover, the terminal used by the one worker may receive information on the appearance of the different worker (e.g., information on what the different worker is wearing, such as clothes). Then, the received information may be displayed on this terminal. The plurality of workers may be strangers who have never met each other before. Thus, in the aforementioned way, when the plurality of workers gather in the proximity of mobile body 20, the one worker can use the information on the appearance of the different worker to identify this different worker. This helps the plurality of workers perform the task together collaboratively. This in turn contributes to more appropriate service being provided by mobile body 20.

Moreover, when the plurality of workers gather, information indicating that all the supporters are present may be transmitted to the terminals used by the supporters to present this information to the supporters. In this way, when the plurality of workers gather in the proximity of mobile body 20, the one worker can recognize that all the supporters are present. This helps the plurality of workers perform the task together collaboratively. This in turn contributes to more appropriate service being provided by mobile body 20.

### Example 10

When management device 10 has authenticated supporter S1 by performing the authentication (step S111 (see FIG. 5)), output from mobile body 20 may be used to inform those who are in the vicinity of mobile body 20 that supporter S1 is performing the task on mobile body 20. This has the effect of informing those who are in the vicinity of mobile body 20 that supporter S1 who is an authorized worker is performing the task, or more specifically, that no unauthorized person is performing the task on mobile body 20.

In contrast, when someone who has not been authenticated by management device 10 is about to perform or is performing the task on mobile body 20, output from mobile body 20 may be used to issue an alert to those who are in the vicinity of mobile body 20. This has the effect of informing those who are in the vicinity of mobile body 20 that an unauthorized person is performing the task on mobile body 20.

### Example 11

When management device 10 determines the task that needs to be performed by the supporter (step S106 (see FIG. 5)), the operator may be preferentially assigned to the task the operator is capable of. However, when the operator is unavailable to perform this task for a reason, management device 10 may determine that this task needs to be performed by the supporter. Specifically, in “(1) Case where mobile body 20 suffers self-position loss while driving” or “(3) Case where mobile body 20 is stuck while driving” according to the present embodiment described above, the operator may preferentially perform the task. Note that examples of the reason for which the operator is unavailable to perform the task include that the operator is unable to perform the requested task because the operator is performing a different task.

Here, the reason may be eliminated after the call, application, and instruction to perform the task are provided based on the determination that the operator is unavailable to perform the task for a reason. In this case, the task may still be performed by the supporter without change (that is, in the same way as when the reason remains) or the task to be performed by the supporter may be cancelled. When the supporter is a general user, the task may be performed by this supporter even after the reason has been eliminated. This is because the task cancellation may possibly reduce the motivation of the supporter to perform tasks on future requests. However, when the supporter is a maintenance worker, the task may be canceled. This is because the task cancellation allows the maintenance worker to perform a different task. This can contribute to the performance of supporter system 1 as a whole for supporting the task relating to mobile body 20.

### Example 12

When management device 10 generates new request information in response to the additional worker request received as the report information (step S115 (see FIG. 5)), the new request information may be generated after the managerial side determines that the additional worker is necessary. Then, when the additional worker is determined unnecessary, the task to be performed by this worker may be cancelled and a new worker may be called for to perform the task. This can eliminate the need for providing extra compensation for two workers to perform the task that can be performed by one worker. In other words, this can prevent the supporter from fraudulently receiving the compensation. Note that, in this case, the supporter who transmits the additional worker request may be added to a blacklist (a list of users who commit frauds and users who are not allowed to perform standard tasks). Whether the additional worker is necessary can be determined by determining, from a past history for example, whether the task has been performed by one worker alone on mobile body 20 in an identical or similar situation or status. Alternatively, the operator may make this determination by visually checking the surrounding situation of mobile body 20, based on the camera-captured video transmitted from mobile body 20.

### Example 13

Support system 1 can also be used for making an emergency stop of mobile body 20 at the current location when the communication is disconnected between mobile body 20 and management device 10. In this case, management device 10 can request a task, by using the position of mobile body 20 immediately before the disconnection. Examples of the task details may include: finding mobile body 20; notifying the operator when mobile body 20 is found; and moving mobile body 20 to an evacuation place. In addition to information on the position of mobile body 20 immediately before the communication disconnection, the instruction information may also include search support information that is information on the evacuation place located in the vicinity of mobile body 20 immediately before the communication disconnection.

Note that examples of the communication disconnection between mobile body 20 and management device 10 may include a case where the communication condition deteriorates only temporarily and may recover later. In this case, when the communication condition recovers, the autonomous driving of mobile body 20 can be resumed by a remote task of the operator. Thus, the request to perform the task may be unnecessary. On this account, the call information may include information indicating that the task may be cancelled when the communication condition recovers.

Each of the elements in each of the above-described Embodiment may be configured in the form of an exclusive hardware product, or may be realized by executing a software program suitable for the element. Each of the elements may be realized by means of a program executing unit, such as a Central Processing Unit (CPU) or a processor, reading and executing the software program recorded on a recording medium such as a hard disk or semiconductor memory. Here, the software that realizes support system 1 or the like is a program described below.

More specifically, this program causes a computer to execute a support method performed by a support system that provides support for an autonomous mobile body, the support method including: receiving request information indicating a request for the support; determining a task relating to the autonomous mobile body by using the request information received; transmitting, to one or more terminals used by one or more supporters, call information indicating a call for one or more workers who perform the task determined; receiving, from a terminal among the one or more terminals, application information indicating an application for the call; and transmitting instruction information indicating an instruction to perform the task to the terminal that has transmitted the application information.

Although the support system and the like according to one or more aspects of the present disclosure have been described based on the embodiment, the present disclosure is not limited to this embodiment. Those skilled in the art will readily appreciate that embodiments arrived at by making various modifications to the above embodiment or embodiments arrived at by selectively combining elements disclosed in the above embodiment without materially departing from the scope of the present disclosure may be included within one or more aspects of the present disclosure.

### INDUSTRIAL APPLICABILITY

The present disclosure is usable for a system that includes an autonomous mobile body.

1. A support method performed by a support system that provides support for an autonomous mobile body, the support method comprising:
receiving request information indicating a request for the support;
determining a task relating to the autonomous mobile body by using the request information received;
transmitting, to one or more terminals used by one or more supporters, call information indicating a call for one or more workers who perform the task determined;
receiving, from a terminal among the one or more terminals, application information indicating an application for the call; and
transmitting instruction information indicating an instruction to perform the task to the terminal that has transmitted the application information.

2. The support method according to claim 1,
wherein in the transmitting of the call information, the call information is transmitted to the one or more terminals that are within a predetermined distance from the autonomous mobile body.

3. The support method according to claim 1,
wherein in the transmitting of the call information, the call information is transmitted to at least one terminal used by at least one supporter currently available to perform the task among the one or more supporters, the transmitting being performed based on availability information indicating, for each of the one or more supporters, whether the supporter is currently available to perform the task.

4. The support method according to claim 1,
wherein in the transmitting of the call information, the call information is transmitted, based on ability information indicating a task ability level for each of the one or more supporters, to at least one terminal used by at least one supporter having the task ability level that satisfies a predetermined condition among the one or more supporters.

5. The support method according to claim 1,
wherein the task includes at least one of: a task of securing a moving route for the autonomous mobile body; a task of moving the autonomous mobile body; a task of repairing the autonomous mobile body; or a task of having a remote interaction via the autonomous mobile body.

6. The support method according to claim 1,
wherein in the determining, a plurality of tasks are determined, the plurality of tasks each being the task, and in the transmitting of the call information, for each of the plurality of tasks determined, the call information indicating the call for the one or more workers who perform the task is transmitted.

7. The support method according to claim 1,
wherein in the receiving, the request information is received from the autonomous mobile body, from a terminal used by an operator who remotely operates the autonomous mobile body, or from a terminal among the one or more terminals used by the one or more supporters.

8. The support method according to claim 1,
wherein in the transmitting of the call information, the call information indicating the call for a plurality of workers as the one or more workers is transmitted.

9. The support method according to claim 1, further comprising:
performing provision processing of providing compensation to the one or more workers when report information indicating that the task has been completed is received, the report information being transmitted from the terminal according to the instruction information transmitted.

10. The support method according to claim 9,
wherein when the one or more workers are a plurality of workers, the provision processing includes processing, to each of the plurality of workers, compensation that is higher as the worker has arrived earlier at a position where the autonomous mobile body is present.

11. A terminal used by a supporter who provides support for an autonomous mobile body, the terminal comprising:
a controller; and
a communication unit connected to the controller,
wherein, by using the communication unit, the controller:
receives call information indicating a call for one or more workers who perform a task relating to the autonomous mobile body, the task being determined based on request information indicating a request for the support;
transmits application information indicating an application for the call indicated in the call information received; and
receives instruction information indicating an instruction to perform the task.

12. A support system that provides support for an autonomous mobile body, the support system comprising:
a receiver that receives request information indicating a request for the support;
a task determiner that determines a task relating to the autonomous mobile body by using the request information received; and
a task manager that: transmits, to one or more terminals used by one or more supporters, call information indicating a call for one or more workers who perform the task determined; receives, from a terminal among the one or more terminals, application information indicating an application for the call; and transmits instruction information indicating an instruction to perform the task to the terminal that has transmitted the application information.

13. A control method performed by a terminal used by a supporter who provides support for an autonomous mobile body, the control method comprising:
receiving call information indicating a call for one or more workers who perform a task relating to the autonomous mobile body, the task being determined based on request information indicating a request for the support;
transmitting application information indicating an application for the call indicated in the call information received; and
receiving instruction information indicating an instruction to perform the task.
